(19) United States
(12) Patent Application Publication
(10) Pub. No.: US 2024/0116337 A1
(43) Pub. Date: Apr. 11, 2024

(54) Body and Closures

(71) Applicant: Apple Inc., Cupertino, CA (US)

(72) Inventors: Ali Tavakoli Targhi, San Jose, CA (US); Philipp J. Wolf, Capistrano Beach, CA (US); Steven H. Klotz, Austin, TX (US); Moshe J. Baum, Merritt Island, FL (US); Tina Lin, Mountain View, CA (US); Donald R. Monroe, Los Gatos, CA (US)

(21) Appl. No.: 18/539,795

(22) Filed: Dec. 14, 2023

Related U.S. Application Data
(63) Continuation of application No. PCT/US2022/036990, filed on Jul. 13, 2022.
(60) Provisional application No. 63/227,183, filed on Jul. 29, 2021.

(51) Int. Cl. B60J 5/04; B60J 7/16; B60R 3/02

(52) U.S. Cl. CPC B60J 5/0473; B60J 7/1621; B60J 7/1642; B60R 3/02; E05F 15/00

(57) ABSTRACT

A closure includes a door configured for movement with respect to an opening between a closed position and an open position, and a movable roof panel that configured for connection to the body for movement with respect to the opening between a closed position and an open position by pivoting relative to the body. The closure also includes an access structure that is configured to be movable from a stowed position to a deployed position when the door is in the open position, wherein the access structure defines a walking surface in the deployed position.

### CROSS-REFERENCE TO RELATED APPLICATIONS

This application is a continuation of International Application No. PCT/US2022/036990, filed on Jul. 13, 2022, which claims the benefit of U.S. Provisional Application No. 63/227,183, filed on Jul. 29, 2021. The contents of the foregoing applications are hereby incorporated by reference herein in their entireties for all purposes.

### TECHNICAL FIELD

This disclosure relates to bodies and closures.

### BACKGROUND

Body structures may incorporate openings. Closures may be connected to the body structure in a manner that permits movement of the closure between a closed position and an open position.

### SUMMARY

A first aspect of the disclosure is a vehicle that includes a vehicle body, an opening that is defined by the vehicle body, a door, and an access structure. The door is connected to the vehicle body for movement between a closed position and an open position by pivoting outward and downward relative to the vehicle body. The access structure is connected to the door and is movable from a stowed position to a deployed position when the door is in the open position, wherein the access structure defines a walking surface in the deployed position.

In some implementations of the vehicle according to the first aspect of the disclosure, the access structure includes a movable ramp. The movable ramp may be located inside the door in the stowed position and may extend outward from the door in the deployed position. The movable ramp may be located adjacent to an interior surface of the door in the stowed position and may extend outward from the door in the deployed position. A first walking surface portion of the walking surface may be defined by the door when the access structure is in the deployed position and a second walking surface portion of the walking surface may be defined by the movable ramp when the access structure is in the deployed position. The movable ramp may be configured to translate with respect to the door during movement of the access structure from the stowed position to the deployed position. The movable ramp may be configured to pivot with respect to the door during movement of the access structure from the stowed position to the deployed position.

In some implementations of the vehicle according to the first aspect of the disclosure, the access structure includes a stairway assembly that includes movable stair treads that are connected to the door and move with respect to the door during movement of the access structure between the stowed position and the deployed position, wherein each of the movable stair treads defines a walking surface portion of the walking surface when the access structure is in the deployed position. The movable stair treads may be positioned adjacent to the door when the access structure is in the stowed position and the movable stair treads may be disposed at an angle relative to the door when the access structure is in the deployed position.

In some implementations of the vehicle according to the first aspect of the disclosure, the access structure includes a movable ramp, the access structure includes a stairway assembly, and movement of the access structure from the stowed position to the deployed position includes movement of a selected one of the movable ramp or the stairway assembly to a respective deployed position. The movable ramp may be located inside the door in the stowed position of the access structure and the stairway assembly may be located adjacent to an interior surface of the door in the stowed position of the access structure.

A second aspect of the disclosure is a vehicle that includes a vehicle body, an opening that is defined by the vehicle body, a door, and a window. The door is connected to the vehicle body for movement between a closed position and an open position by pivoting outward and downward relative to the vehicle body. The window is connected to the vehicle body for movement between a closed position and an open position, wherein the window and the door move independently.

In some implementations of the vehicle according to the second aspect of the disclosure, the window is connected to the vehicle body by a movement mechanism that is operable to move the window between the closed position and the open position by pivoting the window upward and inward relative to the vehicle body. In some implementations of the vehicle according to the second aspect of the disclosure, the window is connected to the vehicle body by a movement mechanism that is operable to move the window between the closed position and the open position by translation of the window longitudinally relative to the vehicle body.

In some implementations of the vehicle according to the second aspect of the disclosure, the vehicle includes a movable ramp that is connected to the door and is movable between a stowed position and a deployed position with respect to the door, wherein the movable ramp defines a walking surface in the deployed position. In some implementations of the vehicle according to the second aspect of the disclosure, the vehicle includes a stairway assembly that includes movable stair treads that are connected to the door and move with respect to the door between a stowed position and a deployed position, wherein each of the movable stair treads defines a walking surface portion in the deployed position.

A third aspect of the disclosure is a vehicle that includes a vehicle body, an opening that is defined by the vehicle body, a door, and a movable ramp. The door is connected to the vehicle body for movement between a closed position and an open position by moving outward in a lateral direction of the vehicle body during a first motion phase and by moving in a longitudinal direction of the vehicle body during a second motion phase. The movable ramp is connected to the vehicle body for movement between a stowed position and a deployed position by moving outward in the lateral direction of the vehicle body in correspondence with movement of the door during the first motion phase and by moving outward and downward relative to the vehicle body in a third motion phase.

In some implementations of the vehicle according to the third aspect of the disclosure, an outer end of the movable ramp is positioned adjacent to the door in the first motion phase. In some implementations, a gap of fifty millimeters or less is defined between an outer end of the movable ramp and the door during the first motion phase. In some implementations, the movable ramp is located under a floor surface of the vehicle body in the stowed position.

A fourth aspect of the disclosure is a vehicle that includes a vehicle body, an opening that is defined by the vehicle body, a closure panel, and a movement mechanism. The movement mechanism connects the closure panel to the vehicle body. The movement mechanism is configured to move the closure panel between a closed position and a first open position by moving the closure panel upward and outward relative to the vehicle body. The movement mechanism is configured to move the closure panel between the closed position and a second open position by pivoting the closure panel upward and inward relative to the vehicle body. In some implementations of the vehicle according to the fourth aspect of the disclosure, the movement mechanism is configured to support the closure panel for translation relative to the vehicle body in the first open position. The movement mechanism may include a first movement stage that is configured to move the closure panel between the closed position and the first open position, and a second movement stage that is configured to move the closure panel between the closed position and the second open position. The first movement stage may support the closure panel with respect to the vehicle body in a manner that allows translation of the closure panel with respect to the vehicle body in the first open position. In some implementations, movement of the closure panel from the closed position to the first open position causes disconnection of the closure panel from the second movement stage.

In some implementations of the vehicle according to the fourth aspect of the disclosure, the vehicle includes a sliding latch assembly that is configured to connect the vehicle body to the closure panel, wherein the sliding latch assembly is movable between a latched position and an unlatched position. In some implementations of the vehicle according to the fourth aspect of the disclosure, the sliding latch assembly is in the latched position when the closure panel is in the closed position, the sliding latch assembly is in the latched position when the closure panel is in the first open position, and the sliding latch assembly is in the unlatched position when the closure panel is in the first open position. In some implementations of the vehicle according to the fourth aspect of the disclosure, the sliding latch assembly includes a sliding joint that allows translation of the of the closure panel with respect to the vehicle body when the closure panel is in the first open position and the sliding latch assembly is in the latched position. In some implementations of the vehicle according to the fourth aspect of the disclosure, the sliding latch assembly is located near a lower end of the closure panel and the movement mechanism is located near an upper end of the closure panel.

In some implementations of the vehicle according to the fourth aspect of the disclosure, the vehicle body includes a roof portion, and the movement mechanism is connected to the roof portion of the vehicle body. In some implementations of the vehicle according to the fourth aspect of the disclosure, the vehicle includes a door that is connected to the vehicle body for movement between a closed position and an open position, wherein the door is located in the opening in the closed position of the door. In some implementations, the closure panel includes a lower part that is adjacent to a side portion of the vehicle body in the closed position and an upper part that is adjacent to a roof portion of the vehicle body in the closed position.

A fifth aspect of the disclosure is a movement mechanism for moving a closure panel with respect to a vehicle body. The movement mechanism includes a support structure that is fixed to the closure panel and includes a first coupler part, a first movement stage, and a second movement stage. The first movement stage is connected to the support structure and is configured to move the closure panel between a closed position and a first open position with respect to the vehicle body. The second movement stage includes a second coupler part, is configured to connect to the support structure by engagement of the first coupler part with the second coupler part, and is configured to move the closure panel between the closed position and the second open position. The first coupler part is connected to the second coupler part in the closed position, the first coupler part is disconnected from the second coupler part in the first open position, and the first coupler part is connected to the second coupler part in the second open position.

In some implementations of the movement mechanism according to the fifth aspect of the disclosure, the first movement stage of the movement mechanism is configured to move the closure panel from the closed position to the first open position by moving the closure panel upward and outward relative to the vehicle body. In some implementations of the movement mechanism according to the fifth aspect of the disclosure, the second movement stage of the movement mechanism is configured to move the closure panel from the closed position to the second open position by pivoting the closure panel upward and inward relative to the vehicle body. In some implementations of the movement mechanism according to the fifth aspect of the disclosure, the first movement stage supports the closure panel with respect to the vehicle body in a manner that allows translation of the closure panel with respect to the vehicle body in the first open position.

A sixth aspect of the disclosure is a sliding latch assembly for connecting a closure panel to a vehicle body. The sliding latch assembly includes a first latch part that is connected to the vehicle body and a second latch part that is connected to the closure panel. The first latch part and the second latch part are movable between a latched position and an unlatched position. The second latch part includes a sliding joint that allows translation of the closure panel with respect to the vehicle body in the latched position.

In some implementations of the sliding latch assembly according to the sixth aspect of the disclosure, the first latch part includes a latch member, the second latch part includes a striker, the latch member is connected to the striker in the latched position, and the latch member is disconnected from the striker in the unlatched position. The first latch part may be connected to the vehicle body in a manner that allows pivoting of the first latch part with respect to the vehicle body. The second latch part may include a slide member and a guide member that is connected to the closure panel, and the sliding joint is defined by connection of the slide member to the guide member in a manner that allows the slide member to slide along the guide member.

A seventh aspect of the disclosure is a vehicle that includes a vehicle body, an opening that is defined by the vehicle body, and a door. The door is connected to the vehicle body for movement between a closed position and an open position, wherein the door includes an interior surface. A movable stair tread is connected to the door and has a first surface and a second surface. The movable stair tread is movable between a first position in which the first surface faces away from the door and second position in which the second surface faces away from the door.

In some implementations of the vehicle according to the seventh aspect of the disclosure, the first surface of the movable stair tread and the second surface of the movable stair tread are on opposite sides of the movable stair tread. The vehicle according to the seventh aspect of the disclosure may also include a stair movement mechanism that connects the movable stair tread to the door and is configured to move the movable stair tread between the first position and the second position. In some implementations of the vehicle according to the seventh aspect of the disclosure, the stair movement mechanism includes a linkage and an actuator assembly, wherein the linkage is connected to the movable stair tread, and the actuator assembly drives movement of the linkage to cause the stair movement mechanism to move the movable stair tread between the first position and the second position. In some implementations, the linkage includes a first link that is connected to the movable stair tread, the linkage includes a second link that is connected to the movable stair tread, and the actuator assembly is configured to move the first link and the second link. In some implementations, the stair movement mechanism includes a first guide structure, a second guide structure, a first slide member that is connected to the first link of the linkage and is configured to move along the first guide structure, and a second slide member that is connected to the second link of the linkage and is configured to move along the second guide structure.

In some implementations of the vehicle according to the seventh aspect of the disclosure, the first surface of the movable stair tread is located adjacent to the interior surface of the door in the first position of the movable stair tread. In some implementations, the first surface of the movable stair tread is aligned with the interior surface of the door in the first position of the movable stair tread. In some implementations, the second surface of the movable stair tread defines a walking surface portion for allowing access to the vehicle in the second position. In some implementations, the movable stair tread is disposed in alignment with the interior surface of the door in the first position and the movable stair tread is disposed at an angle relative to the interior surface of the door in the second position. In some implementations, the movable stair tread is movable to a third position in which the second surface faces away from the door and the movable stair tread is disposed in alignment with the interior surface of door.

In some implementations of the vehicle according to the seventh aspect of the disclosure, the door moves from the closed position to the open position by pivoting outward and downward relative to the vehicle body. In some implementations, the door is connected to the vehicle body at a lower end of the door and an upper end of the door is located at a lower elevational position than a floor surface of the vehicle body when the door is in the open position.

In some implementations of the vehicle according to the seventh aspect of the disclosure, the vehicle includes a movable ramp that includes a ramp housing and a ramp portion, the ramp housing includes an open end that is located at an upper end of the door, and the ramp portion is movable between a stowed position, in which the ramp portion is located inside the ramp housing, and a deployed position, in which at least part of the ramp portion extends out of the open end of the ramp housing to define a first walking surface portion for allowing access to the vehicle. In some implementations, the movable stair tread is movable to a third position in which the second surface faces away from the door and the movable stair tread is disposed in alignment with the door, and the movable stair tread is moved to the third position when the ramp portion is moved to the deployed position so that the second surface of the movable stair tread defines a second walking surface portion that is usable with the first walking surface portion for allowing access to the vehicle.

A vehicle according to an eighth aspect of the disclosure includes a vehicle body, an opening that is defined by the vehicle body, and a door. The door is connected to the vehicle body for movement between a closed position and an open position, wherein the door includes an interior surface, wherein the door is connected to the vehicle body at a lower end of the door and an upper end of the door is located at a lower elevational position than a floor surface of the vehicle body when the door is in the open position. A movable stair tread is movable between a stowed position and a deployed position, wherein the movable stair tread is aligned with the interior surface of the door in the stowed position and the movable stair tread is disposed at an angle relative to the interior surface of the door in the deployed position to define a walking surface portion for allowing access to the vehicle. A stair movement mechanism connects the movable stair tread to the door and is configured to move the movable stair tread between the stowed position and the deployed position.

In some implementations of the vehicle according to the eighth aspect of the disclosure, the stair movement mechanism includes a linkage and an actuator assembly, wherein the linkage is connected to the movable stair tread, and the actuator assembly drives movement of the linkage to cause the stair movement mechanism to move the movable stair tread between the stowed position and the deployed position. In some implementations of the vehicle according to the eighth aspect of the disclosure, the linkage includes a first link that is connected to the movable stair tread, the linkage includes a second link that is connected to the movable stair tread, and the actuator assembly is configured to move the first link and the second link. In some implementations of the vehicle according to the eighth aspect of the disclosure, the stair movement mechanism includes a first guide structure, a second guide structure, a first slide member that is connected to the first link of the linkage and is configured to move along the first guide structure, and a second slide member that is connected to the second link of the linkage and is configured to move along the second guide structure.

A ninth aspect of the disclosure is a vehicle that includes a vehicle body, an opening that is defined by the vehicle body, and a door that is connected to the vehicle body for movement between a closed position and an open position, wherein the door includes an interior surface. A movable ramp is connected to the door and is movable between a stowed position and a deployed position, wherein the movable ramp defines a first walking surface portion in the deployed position. A movable structure is connected to the door, has a first surface, and has a second surface, wherein the movable structure is movable between a first position in which the first surface is positioned adjacent to the interior surface of the door and second position in which the second surface is positioned adjacent to the interior surface of the door, wherein the second surface defines a second walking surface portion in the second position. The first walking surface portion and the second walking surface portion cooperate to allow access to the vehicle.

In some implementations of the vehicle according to the ninth aspect of the disclosure, the movable ramp includes a ramp housing and a ramp portion, the ramp housing includes an open end that is located at an upper end of the door, the ramp portion is located inside the ramp housing in the stowed position, and at least part of the ramp portion extends out of the open end of the ramp housing in the deployed position. The movable structure may be a movable stair tread that is movable to a third position in which the movable stair tread extends at an angle with respect to the door.

A tenth aspect of the disclosure is a vehicle that includes a vehicle body, an opening that is defined by the vehicle body, a door that is connected to the vehicle body for movement with respect to the opening between a closed position and an open position, a movable roof panel, and an access structure. The movable roof panel is connected to the vehicle body for movement with respect to the opening between a closed position and an open position by pivoting relative to the vehicle body. The access structure is movable from a stowed position to a deployed position when the door is in the open position, wherein the access structure defines a walking surface in the deployed position.

In some implementations of the vehicle according to the tenth aspect of the disclosure, the access structure includes a movable ramp that is located under a floor surface of the vehicle body in the stowed position. In some implementations of the vehicle according to the tenth aspect of the disclosure, the door is connected to the vehicle body for movement between the closed position and the open position by moving outward in a lateral direction of the vehicle body during a first motion phase and by moving in a longitudinal direction of the vehicle body during a second motion phase. In some implementations of the vehicle according to the tenth aspect of the disclosure, the movable ramp is configured to move between the stowed position and the deployed position by moving outward in the lateral direction of the vehicle body in correspondence with movement of the door during the first motion phase and by moving outward and downward relative to the vehicle body in a third motion phase. In some implementations of the vehicle according to the tenth aspect of the disclosure, an outer end of the movable ramp is positioned adjacent to the door in the first motion phase. In some implementations of the vehicle according to the tenth aspect of the disclosure, a gap of fifty millimeters or less is defined between an outer end of the movable ramp and the door during the first motion phase.

In some implementations of the vehicle according to the tenth aspect of the disclosure, the door moves between the closed position and the open position by pivoting downward and outward relative to the vehicle body, and the access structure includes a movable ramp that is located inside the door in the stowed position and extends outward from the door in the deployed position. In some implementations of the vehicle according to the tenth aspect of the disclosure, the door moves between the closed position and the open position by pivoting downward and outward relative to the vehicle body, and the access structure includes a movable ramp that is located adjacent to an interior surface of the door in the stowed position and extends outward from the door in the deployed position. In some implementations of the vehicle according to the tenth aspect of the disclosure, the door moves between the closed position and the open position by pivoting downward and outward relative to the vehicle body, the access structure includes a movable ramp, a first walking surface portion of the walking surface is defined by the door when the access structure is in the deployed position and a second walking surface portion of the walking surface is defined by the movable ramp when the access structure is in the deployed position. In some implementations of the vehicle according to the tenth aspect of the disclosure, the door moves between the closed position and the open position by pivoting downward and outward relative to the vehicle body, and the access structure includes a movable ramp that is configured to translate with respect to the door during movement of the access structure from the stowed position to the deployed position. In some implementations of the vehicle according to the tenth aspect of the disclosure, the door moves between the closed position and the open position by pivoting downward and outward relative to the vehicle body, and the access structure includes a movable ramp that is configured to pivot with respect to the door during movement of the access structure from the stowed position to the deployed position.

In some implementations of the vehicle according to the tenth aspect of the disclosure, the door moves between the closed position and the open position by pivoting downward and outward relative to the vehicle body, the access structure includes a stairway assembly that includes movable stair treads that are connected to the door and move with respect to the door during movement of the access structure between the stowed position and the deployed position, and each of the movable stair treads defines a walking surface portion of the walking surface when the access structure is in the deployed position. In some implementations of the vehicle according to the tenth aspect of the disclosure, the movable stair treads are positioned adjacent to the door when the access structure is in the stowed position and the movable stair treads are disposed at an angle relative to the door when the access structure is in the deployed position. In some implementations of the vehicle according to the tenth aspect of the disclosure, the access structure includes a movable ramp, the access structure includes a stairway assembly, and movement of the access structure from the stowed position to the deployed position includes movement of a selected one of the movable ramp or the stairway assembly to a respective deployed position. In some implementations of the vehicle according to the tenth aspect of the disclosure, the movable ramp is located inside the door in the stowed position of the access structure and the stairway assembly is located adjacent to an interior surface of the door in the stowed position of the access structure.

### BRIEF DESCRIPTION OF THE DRAWINGS

FIG. 1 is a schematic illustration of a portion of a vehicle.

FIG. 2 is a schematic cross-section illustration that shows a closure assembly in a closed position.

FIG. 3 is a schematic cross-section illustration that shows the closure assembly of the vehicle in an open position, and shows a stairway assembly in a deployed position.

FIG. 4 is a schematic cross-section illustration that shows the closure assembly of the vehicle in an open position, and shows a movable ramp in a deployed position.

FIG. 5 is a schematic cross-section illustration that shows the window of the closure assembly of the vehicle in the open position, and the door in a closed position.

FIG. 6 is a perspective illustration that shows a window translated in a longitudinal direction away from an opening of the vehicle body.

FIG. 7 is a schematic cross-section illustration that shows the window of the closure assembly of the vehicle in the open position, and shows the door of the vehicle in a closed position.

FIG. 8 is a perspective illustration of the vehicle with the window translated away from the opening in a longitudinal direction of the vehicle.

FIG. 9 is a schematic cross-section illustration that shows an alternative implementation of a closure assembly in a closed position.

FIG. 10 is a schematic cross-section illustration that shows a side window portion of the closure assembly of FIG. 9 in an open position and shows a movable roof portion, and a door of the closure assembly of FIG. 9 in a closed position

FIG. 11 is a schematic cross-section illustration that shows the side window portion, the movable roof portion, and the door of the closure assembly of FIG. 9 in the open position, and shows the stairway assembly in the deployed position.

FIG. 12 is a schematic cross-section illustration that shows the side window portion, the movable roof portion, and the door of the closure assembly of FIG. 9 in the open position, and shows the movable ramp in the deployed position.

FIG. 13 is a schematic cross-section illustration that shows an alternative implementation of a closure assembly in a closed position.

FIG. 14 is a schematic cross-section illustration that shows the closure assembly of FIG. 13 in an open position.

FIG. 15 is a schematic cross-section illustration taken along line A-A of FIG. 13 that shows the closure assembly of FIG. 13 prior to a first motion phase.

FIG. 16 is a schematic cross-section illustration taken along line A-A of FIG. 13 that shows the closure assembly of FIG. 13 prior to a second motion phase and a third motion phase.

FIG. 17 is a schematic cross-section illustration taken along line A-A of FIG. 13 that shows the closure assembly of FIG. 13 subsequent to the second motion phase and the third motion phase.

FIG. 18 is a schematic cross-section illustration that shows an upper closure panel in a closed position.

FIG. 19 is a schematic cross-section illustration that shows the upper closure panel in a first open position.

FIG. 20 is a schematic cross-section illustration that shows the upper closure panel in a second open position.

FIG. 21 is a schematic side view illustration that shows the upper closure panel in the closed position.

FIG. 22 is a schematic side view illustration that shows the upper closure panel in the first open position.

FIG. 23 is a schematic front cross-section illustration of the movement mechanism with the upper closure panel in the closed position.

FIG. 24 is a schematic side cross-section illustration of the movement mechanism with the upper closure panel in the closed position.

FIG. 25 is a schematic front cross-section illustration of the movement mechanism with the upper closure panel in the first open position.

FIG. 26 is a schematic side cross-section illustration of the movement mechanism with the upper closure panel in the first open position.

FIG. 27 is a schematic front cross-section illustration of the movement mechanism with the upper closure panel in the first open position.

FIG. 28 is a schematic cross section illustration showing the sliding latch assembly in the latched position with the upper closure panel in the closed position.

FIG. 29 is a schematic cross section illustration showing the sliding latch assembly in the latched position with the upper closure panel in the first open position.

FIG. 30 is a schematic cross section illustration showing the sliding latch assembly in the unlatched position with the upper closure panel moving between the closed position and the second open position.

FIG. 31 is a front cross-section illustration of a movement mechanism according to an alternative implementation with the window in a closed position.

FIG. 32 is a front cross-section illustration of the movement mechanism of FIG. 31 with the window in the first open position.

FIG. 33 is a front cross-section illustration of the movement mechanism of FIG. 31 with the window in the second open position.

FIG. 34 is a side cross-section illustration of a movement mechanism according to an alternative implementation with the window in a closed position.

FIG. 35 is a side cross-section illustration of the movement mechanism of FIG. 34 with the window in the first open position.

FIG. 36 is a front cross-section illustration that shows a lower closure panel in a closed position.

FIG. 37 is a front cross-section illustration that shows the lower closure panel of FIG. 36 in an open position with a stairway assembly in a deployed position.

FIG. 38 is a front cross-section illustration that shows the lower closure panel of FIG. 36 in an open position with a movable ramp in a deployed position.

FIG. 39 is a schematic illustration that shows a first movable stair tread and a second movable stair tread of the stairway assembly of FIG. 37 in a first position.

FIG. 40 is a schematic illustration that shows the first movable stair tread and the second movable stair tread of the stairway assembly of FIG. 37 in a first intermediate position during movement between the first position and a second position.

FIG. 41 is a schematic illustration that shows the first movable stair tread and the second movable stair tread of the stairway assembly of FIG. 37 in a second intermediate position during movement between the first position and the second position.

FIG. 42 is a schematic illustration that shows the first movable stair tread and a second movable stair tread of the stairway assembly of FIG. 37 in the second position.

FIG. 43 is a schematic illustration that shows the first movable stair tread and a second movable stair tread of the stairway assembly of FIG. 37 in a third position.

FIG. 44 is a schematic illustration that shows a movement mechanism of the stairway assembly of FIG. 37.

FIG. 45 is a schematic illustration that shows a ramp portion of the movable ramp of FIG. 38 in a stowed position.

FIG. 46 is a schematic illustration that shows a ramp portion of the movable ramp of FIG. 38 in an intermediate position.

FIG. 47 is a schematic illustration that shows a ramp portion of the movable ramp of FIG. 38 in a deployed position.

FIG. 48 is a block diagram of a vehicle according to an example.

FIG. 49 is a block diagram of a control system according to an example.

### DETAILED DESCRIPTION

This disclosure is directed to closures, such as windows and doors for vehicle bodies. The closure assemblies, windows, doors, movement mechanisms, and other devices that are shown and described herein may enhance access to a vehicle, by allowing persons to enter the vehicle without traversing a large step, by allowing persons to enter the vehicle while standing upright, and/or by allowing persons to enter the vehicle while using a mobility device, such as a wheelchair. The closure assemblies, windows, doors, movement mechanisms, and other devices that are shown and described herein may also enhance the user's experience, by packaging mechanical components in a manner that obscures their presence or makes them less visible to occupants, or in a manner that hides unfinished and/or dirt-accumulating surfaces when they are not in use.

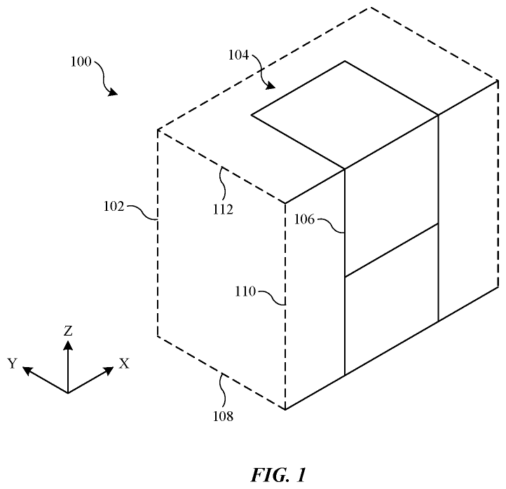

FIG. 1 is a schematic illustration of a portion of a vehicle 100 that includes a vehicle body 102 and a closure assembly 104 that is positioned in an opening 106 that is defined by the vehicle body 102. The closure assembly 104 is in a closed position in FIG. 1. The broken lines shown in FIG. 1 indicate that portions of the vehicle 100, including portions of the vehicle body 102, are not shown. As an example, the vehicle 100 may be a road-going vehicle that includes conventional components, such as a wheels, tires, suspension components, and other components, which are not shown for clarity.

The vehicle body 102 includes interior and exterior components of the vehicle 100 including components that are structural and/or aesthetic in nature. The vehicle body 102 extends in a longitudinal direction X (e.g., front-to-back), a lateral direction Y (e.g., side-to-side, not shown in FIG. 1), and in an elevational direction Z (e.g., top-to-bottom). The vehicle body 102 defines a vehicle interior (not shown) of the vehicle 100, such as a passenger compartment and/or a cargo compartment. The vehicle body 102 may include a floor portion 108, a side portion 110, and a roof portion 112.

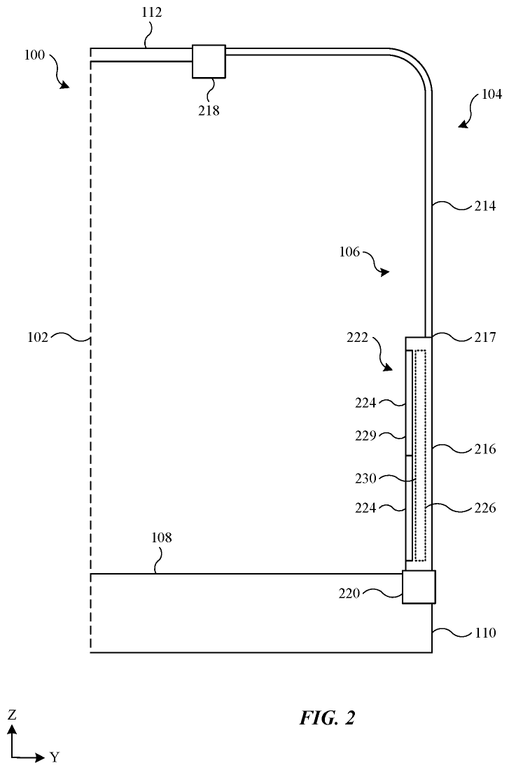

FIG. 2 is a schematic cross-section illustration that shows the closure assembly 104 of the vehicle 100 in the closed position. The closure assembly 104 may include an upper closure panel and a lower closure panel that are each movable relative to the vehicle body 102 and cooperate to occupy (e.g., close) the opening 106 in the closed position, with the upper closure panel being positioned above the lower closure panel within the opening 106. In the illustrated implementation, the upper closure panel of the closure assembly 104 is implemented in the form of a window 214 (e.g., a panel formed in part from a translucent or transparent material, and which may be framed or frameless in construction), and the lower closure panel of the closure assembly 104 is implemented in the form of a door 216.

The window 214 may be positioned adjacent to the side portion 110 and the roof portion 112 of the vehicle body 102. The window 214 may include a transition (e.g., angled or curved) between a first part (e.g., a lower part) of the window 214 that extends primarily in the elevational direction Z of the vehicle 100 adjacent to the side portion 110 of the vehicle body 102 and a second part (e.g., an upper part) of the window 214 that extends primarily in the transverse direction Y of the vehicle 100 adjacent to the roof portion 112 of the vehicle body 102. A lower end of the window 214 is configured to engage an upper end of the door 216 at a location along the side portion of the vehicle body 102, which is an intermediate location between the roof portion 112 and the floor portion 108 of the vehicle body 102 in the elevational direction Z of the vehicle 100. The door 216 extends downward from the interface with the window 214 toward the floor portion 108 of the vehicle body 102. The window 214 and the door 216 cooperate to occupy (e.g., close) the opening 106 of the vehicle body 102 when the closure assembly 104 is in the closed position.

The window 214 is connected to vehicle body 102 by a first movement mechanism 218 that is configured to move the window 214 with respect to the vehicle body 102. As an example, the first movement mechanism 218 may be connected to the roof portion 112 of the vehicle body 102 to connect the window 214 to the roof portion 112 of the vehicle body 102. The door 216 is connected to vehicle body 102 by a second movement mechanism 220 that is configured to move the window 214 with respect to the vehicle body 102. As an example, the second movement mechanism 220 may be connected to the floor portion 108 of the vehicle body 102 to connect the door 216 to the vehicle body 102. The first movement mechanism 218 and the second movement mechanism 220 include components to connect the window 214 and the door 216 to the vehicle body 102 and components that actuate (e.g., cause) movement of the window 214 and the door 216 with respect to the vehicle body 102. The first movement mechanism 218 and the second movement mechanism 220 may include suitable motion control components, such as electric actuators, hydraulic actuators, pneumatic actuators, hinges, linkages, slides, gears, cams, and/or other motion control components. Specific implementations will be described herein. Because the window 214 and the door 216 have separate connections to the vehicle body 102 (e.g., as opposed to the window 214 being supported by the door 216), the window 214 and the door 216 are able to move independently of each other between their respective open and closed positions.

To assist passengers that are entering or exiting the vehicle 100, the vehicle 100 includes an access (e.g., ingress/egress) structure that is configured to be walked on by a passenger of the vehicle 100 during ingress and/or egress from the vehicle. As an example, the access structure may include a ramp, stairs, or both of a ramp and stairs. In implementations in which the access structure includes both of a ramp and stairs, the ramp and stairs may be selectively deployed, allowing the passenger to choose whether to use the ramp or the stairs, wherein the selected one of the ramp or the stairs is deployed in response to the selection. In the implementation shown in FIG. 2, the vehicle 100 includes a stairway assembly 222 and a movable ramp 226, each of which can be moved independently to allow selection of one of them by the passenger. Thus, movement of the access structure from a stowed position to a deployed position may include movement of a selected one of stairway assembly 222 and the movable ramp 226 to the deployed position, while the other is not deployed.

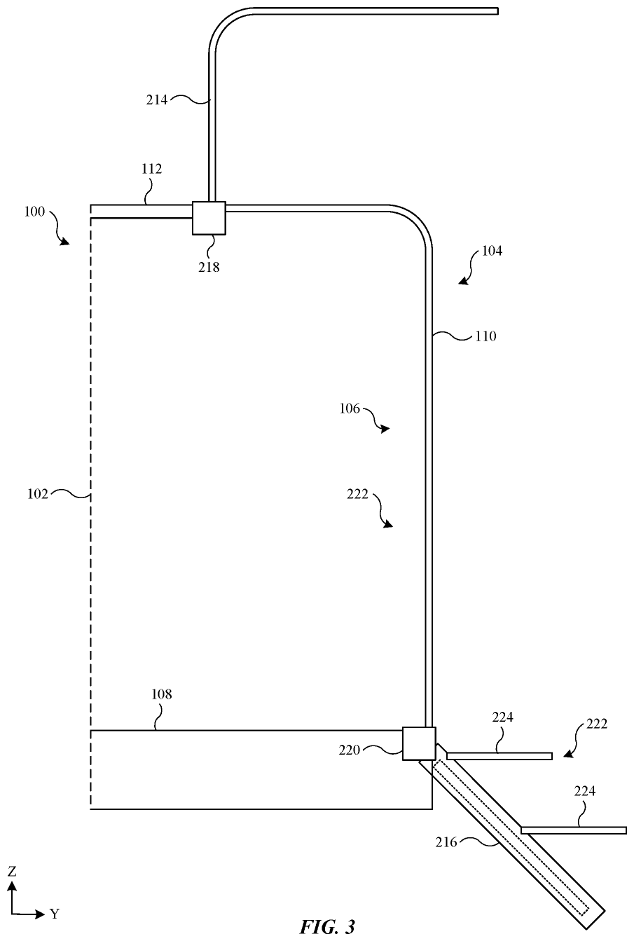

The stairway assembly 222 is connected to the door 216 and includes movable stair treads 224. The stairway assembly 222 is in a stowed position in FIG. 2, in which the movable stair treads 224 are positioned adjacent to or inside the door 216. As an example, the movable stair treads 224 may be positioned against an interior surface of the door 216 and/or generally coincident with the interior surface of the door in the stowed position. The stairway assembly 222 is movable to a deployed position (FIG. 3), as will be described herein.

A stairway assembly 222 is connected to the door 216 and includes movable stair treads 224. The stairway assembly 222 is in the stowed position in FIG. 2, in which the movable stair treads 224 are positioned adjacent to or inside the door 216. As an example, the movable stair treads 224 may be positioned against an interior surface of the door 216 and/or generally coincident with the interior surface of the door 216 in the stowed position.

The stairway assembly 222 is movable to a deployed position to allow use as stairs for ingress to and egress from an interior of the vehicle 100. In the deployed position, the movable stair treads 224 are moved away from the door 216, such as by movement (e.g., pivoting and optionally translation) of the movable stair treads 224 to an angle with respect to the door 216. Thus, the movable stair treads 224 may define portions of a walking surface (e.g., walking surface portions), that are in a generally horizontal orientation while the door 216 is oriented downward relative to the opening 106. Movement of the movable stair treads 224 between the stowed and deployed positions may be implemented using conventional components that are included in the stairway assembly 222, such as linkages and actuators (e.g., electric, hydraulic, or pneumatic).

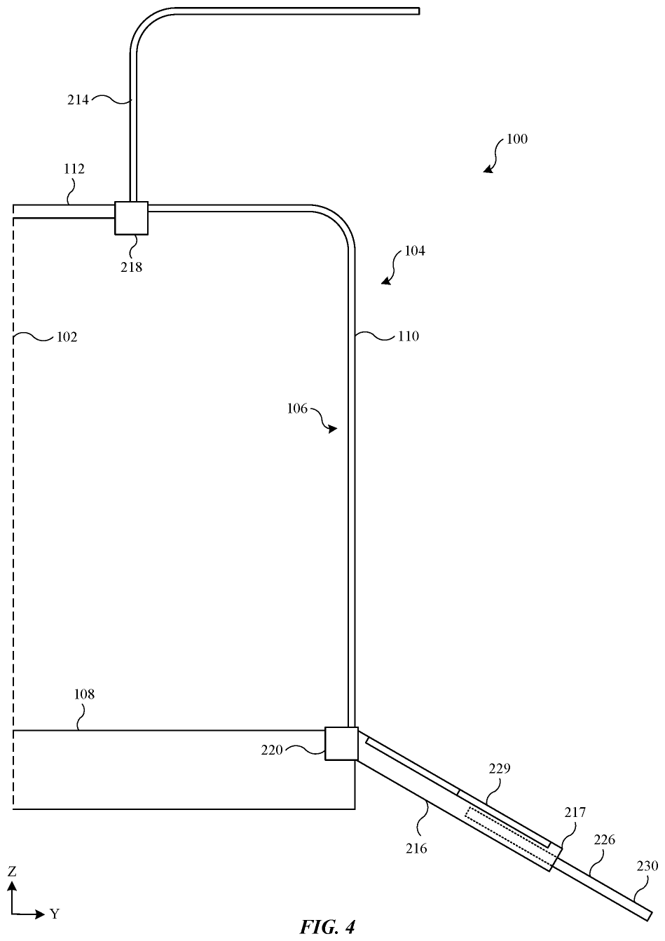

The movable ramp 226 is connected to the door 216. The movable ramp 226 may be located inside the door 216 in a stowed position, as in the illustrated implementation, or may be positioned adjacent to a surface of the door 216 (which may include omission of the stairway assembly 222) in the stowed position. The movable ramp 226 is in the stowed position in FIG. 2, in which the movable ramp 226 is located inboard relative to an upper end 217 of the door 216. The movable ramp 226 is movable to a deployed position (FIG. 4), in which part of the movable ramp 226 extends out of the door 216. In the illustrated implementation, part of the movable ramp 226 extends outward from the upper end 217 of the door, so that a surface of the door 216 and a surface of the movable ramp 226 combine to define a walking surface for use for ingress to and egress from an interior of the vehicle 100. For example, the walking surface may be defined by a first ramp surface portion 229 that is defined on an interior surface of the door 216 and is in general alignment with a second ramp surface portion 230 that is defined on the ramp portion (e.g., aligned sufficiently to allow the ramp surface portions to function as a single ramp). In the illustrated implementation, the movable ramp 226 translates relative to the door 216 during movement between the stowed and deployed positions, in a direction that is generally aligned with the interior surface of the door 216.

FIG. 3 is a schematic cross-section illustration that shows the closure assembly 104 of the vehicle 100 in the open position, and with the stairway assembly 222 in the deployed position. The open position of the closure assembly 104 makes the opening 106 of the vehicle body 102 available for use and ingress and egress, by moving the window 214 and the door 216 away from the opening 106 so that the window 214 and the door 216 do not obstruct the opening 106. The deployed position of the stairway assembly 222 makes the movable stair treads 224 available for use as part of a stairway (e.g., including one or more of the movable stair treads 224, such as two in the illustrated implementation) that facilitates access (e.g., ingress and egress) to an interior of the vehicle 100. Starting from the closed position, the window 214 is moved upward by the first movement mechanism 218, and the door 216 is moved downward and outward by the second movement mechanism 220 to define the open position. Subsequently or concurrently, the movable stair treads 224 of the stairway assembly 222 are moved from the stowed position to the deployed position. These operations are reversed to stow the movable stair treads 224 and to close the closure assembly 104.

To move the closure assembly 104 to open position, the window 214 is pivoted upward relative to the vehicle body 102 by the first movement mechanism 218. Pivoting of the window 214 may be centered on an axis that extends in general correspondence with the longitudinal axis X of the vehicle 100 at an elevational location that generally corresponds to the elevation of the roof portion 112 of the vehicle body 102. As an example, the window 214 may pivot approximately ninety degrees with respect to the vehicle body 102 during movement from the closed position to the open position. As a result, the window 214 is positioned above the opening 106 and does not obstruct the opening 106 in the open position.

To move the closure assembly 104 to open position, the door 216 is pivoted outward and downward relative to the vehicle body 102 by the second movement mechanism 220. Pivoting of the door 216 may be centered on an axis that extends in general correspondence with the longitudinal axis X of the vehicle 100 and is located at an elevational location that generally corresponds to the elevation of the floor portion 108 of the vehicle body. Because a lower end of the door 216 is connected to the second movement mechanism 220, the pivot axis of the door 216 is located near the lower end of the door 216. As an example, the door 216 may pivot approximately one hundred and thirty-five degrees with respect to the vehicle body 102 during movement from the closed position to the open position. As a result, the door 216 moves out of and does not obstruct the opening 106 in the open position, and instead extends downward and outward toward a surface that is located under or near the vehicle 100, such as a road surface, a sidewalk surface, or a ground surface.

To move to the deployed position, the stairway assembly 222 causes the movable stair treads 224 to pivot with respect to the door 216 to orient stair surfaces of the movable stair treads so that the stair surfaces are angled relative to the door 216, are generally level (e.g., within an acceptable degree of deviation from a level orientation that allows a person to stand on them comfortably), and face generally upward.

FIG. 4 is a schematic cross-section illustration that shows the closure assembly 104 of the vehicle 100 in the open position, and with the movable ramp 226 in the deployed position. The open position of the closure assembly 104 makes the opening 106 of the vehicle body 102 available for use and ingress and egress, by moving the window 214 and the door 216 away from the opening 106 so that the window 214 and the door 216 do not obstruct the opening 106. The deployed position of the movable ramp 226 makes the movable ramp available for use as part of a ramp surface that is defined in part by the door 216. As an example, a first ramp surface portion by be defined by the door, and a second ramp surface portion may be defined by the movable ramp 226. Starting from the closed position, the window 214 is moved upward (e.g., by pivoting) by the first movement mechanism 218, and the door 216 is moved downward and outward by the second movement mechanism 220 to define the open position. Subsequently or concurrently, the movable ramp 226 is actuated to slide outward relative to the door 216 from the stowed position to the deployed position. These operations are reversed to stow the movable ramp 226 and to close the closure assembly 104.

Movement of the closure assembly 104 between the open and closed positions during deployment and stowage of the movable ramp 226 is as previously described with reference to FIG. 3. However, the angle of the door 216 maybe different when using the movable ramp 226 as opposed to during usage of the stairway assembly 222. As an example, the door 216 may pivot approximately one hundred and five degrees with respect to the vehicle body 102 during movement from the closed position to the open position when using the movable ramp 226 so that the ramp surface has an inclination angle of approximately fifteen degrees relative to horizontal.

To move to the deployed position, the movable ramp 226 is moved outward relative to the door 216. The angle of the door 216 and/or the length of extension of the movable ramp are controlled (e.g., using signals from sensors) so that the ramp surface defined by the door 216 and the movable ramp 226 extends from the vehicle 100 to the underlying surface, such as a road surface, a sidewalk surface, or a ground surface.

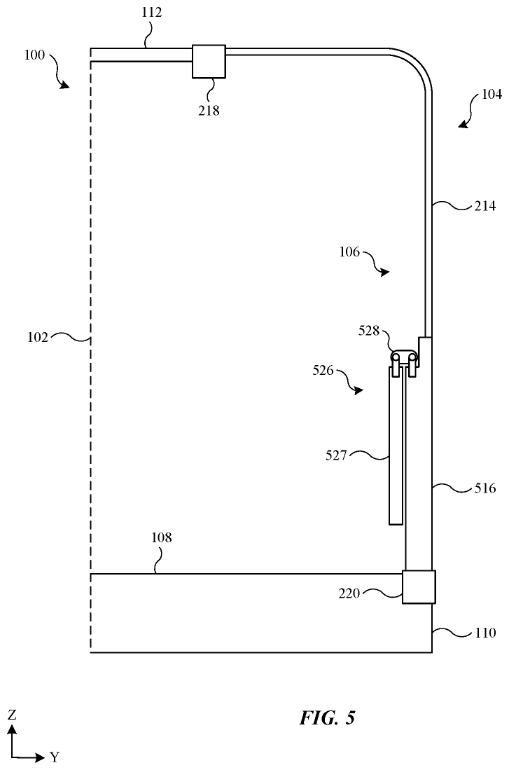

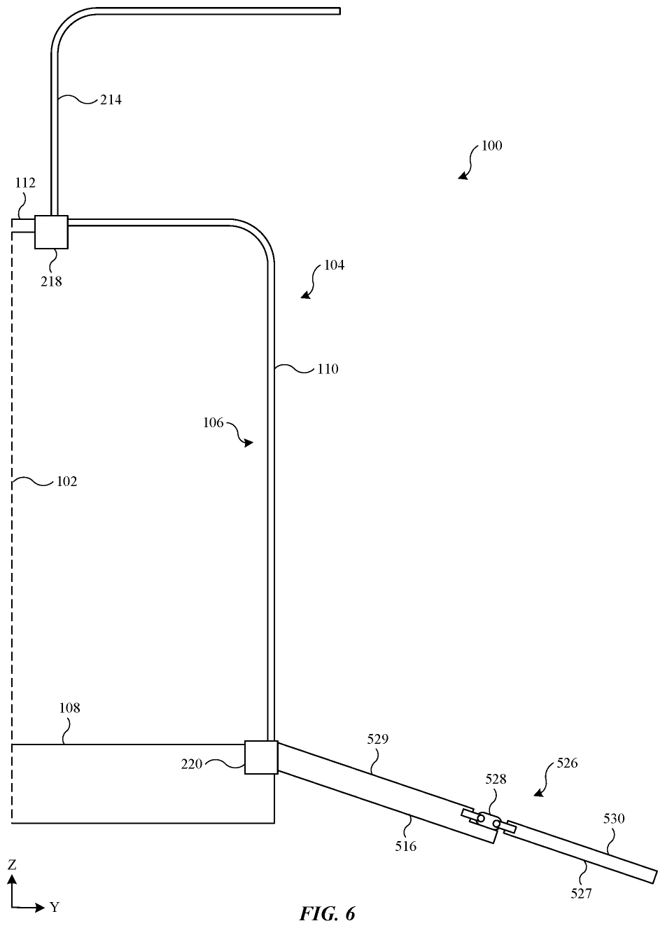

FIG. 5 is a schematic cross-section illustration of an implementation of the vehicle 100 in which the closure assembly 104 is in a closed position and includes a door 516 that includes a folding ramp 526, which is shown in a stowed position. FIG. 6 shows the closure assembly 104 in an open position and shows the folding ramp 526 in an open position. The door 516 replaces the door 216 and the description of the door 216 applies to the door 516 except that the movable ramp 226 is replaced by the folding ramp 526 and the stairway assembly 222 is omitted. Thus, the implementation of FIGS. 5-6 includes an access structure in the form of the folding ramp 526.

The folding ramp 526 includes a ramp portion 527 that is connected to the door 516 by a folding mechanism 528. In the stowed position, the ramp portion 527 is located inboard in the lateral direction Y of the vehicle 100 relative to the door 516 and is positioned adjacent to the door 516 (e.g., the ramp portion 527 is folded against the door 516). Movement of the window 214 and the door 516 of the closure assembly 104 to the open position is the same as previously described with respect to deployment of the movable ramp 226. With the door 516 pivoted outward and downward relative to the vehicle by operation of the second movement mechanism 220, the ramp portion 527 is pivoted with respect to the door 516 by the folding mechanism 528 toward the deployed position, for example, until a first ramp surface portion 529 that is defined on an interior surface of the door 516 is in general alignment with a second ramp surface portion 530 that is defined on the ramp portion 527 (e.g., aligned sufficiently to allow the ramp surface portions to function as a single ramp), wherein the first ramp surface portion 529 and the second ramp surface portion 530 cooperate to define a ramp surface (e.g., a walking surface) that can be used for access (e.g., ingress and egress) to the interior of the vehicle. To move the ramp portion 527 with respect to the door 516 between the stowed and deployed positions, the folding mechanism 528 is a mechanical device that is configured to allow rotation (e.g., around a fixed or non-fixed rotation axis that extends generally in the longitudinal direction of the vehicle 100) of the ramp portion 527 with respect to the door 516. As example, the folding mechanism 528 may include a pivot joint, a geared connection, mechanical linkages, or other structures that are configured to connect two structures for relative pivoting motion. The folding mechanism 528 includes an actuator to drive motion of the ramp portion 527 between the stowed and deployed positions, such a rotary electric motor, a linear electric motor, a hydraulic actuator, or a pneumatic actuator.

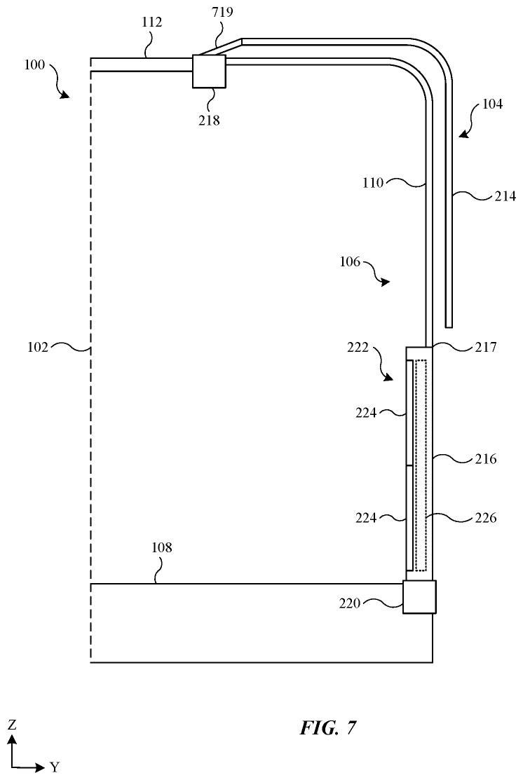

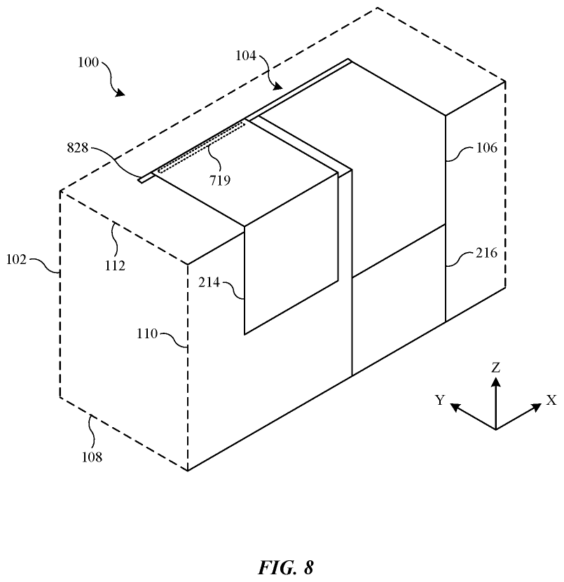

FIG. 7 is a schematic cross-section illustration that shows the window 214 of the closure assembly 104 of the vehicle 100 in the open position, and the door 216 in a closed position. FIG. 8 is a perspective illustration of the vehicle 100 with the window 214 translated away from the opening 106 in the longitudinal direction X of the vehicle 100. In this example, the first movement mechanism 218 is connected to the window 214 by a linkage 719 by which the first movement mechanism 218 is configured to move the window 214 upward and outward (e.g., in the elevational direction Z and in the lateral direction Y by translation) relative to the vehicle body 102. As an example, the first movement mechanism 218 may use an actuator (e.g., electric motor) to cause motion of the linkage 719 and thereby move the window 214 upward and outward. Without movement of the window 214 in the longitudinal direction X of the vehicle, the window 214 is spaced outward and upward from the opening 106 to allow air to enter the interior of the vehicle body 102 through the space between the window 214 and the vehicle body 102. As shown in FIG. 8, the window 214 may be translated in the longitudinal direction of the vehicle 100 after the window 214 is moved upward and outward. This position allows further admission of air into the interior of the vehicle body 102, functioning as an open window. In this position, the door 216 may be moved to the open position, for example, including deploying the stairway assembly 222 or deploying the movable ramp 226 to allow ingress and egress. As an example, the first movement mechanism 218 may include a track 828 that extends in the longitudinal direction X of the vehicle 100, with the linkage 719 being connected to the track 828 to allow the linkage 719 to slide along the track 828 and thus translate the window 214 in the longitudinal direction in unison with the track 828.

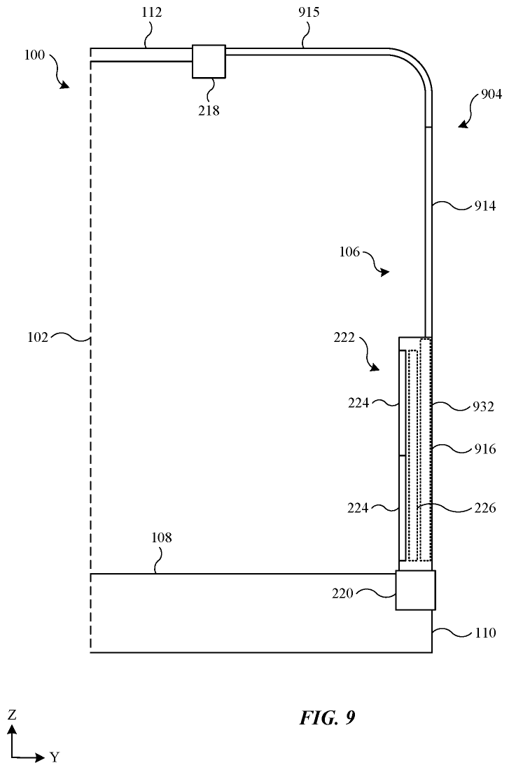

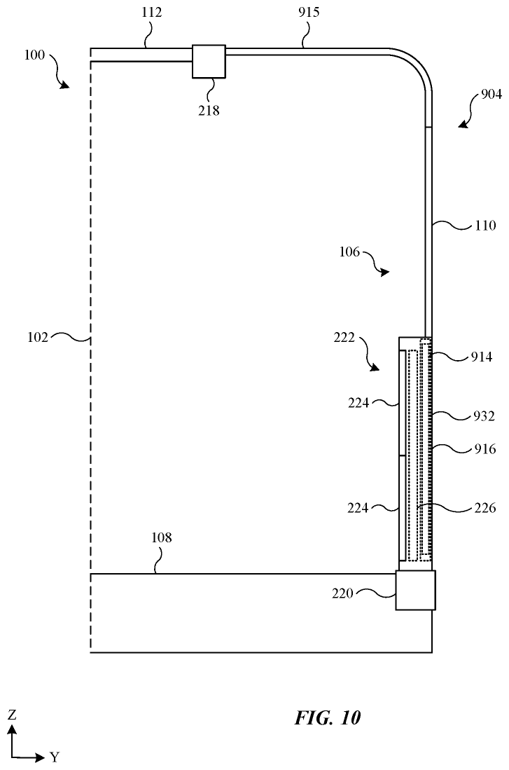

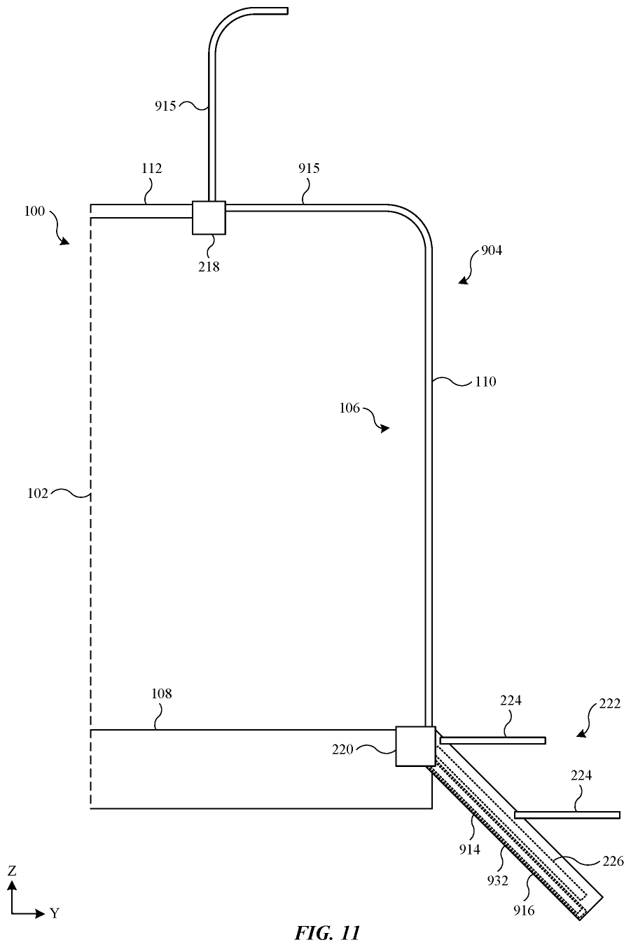

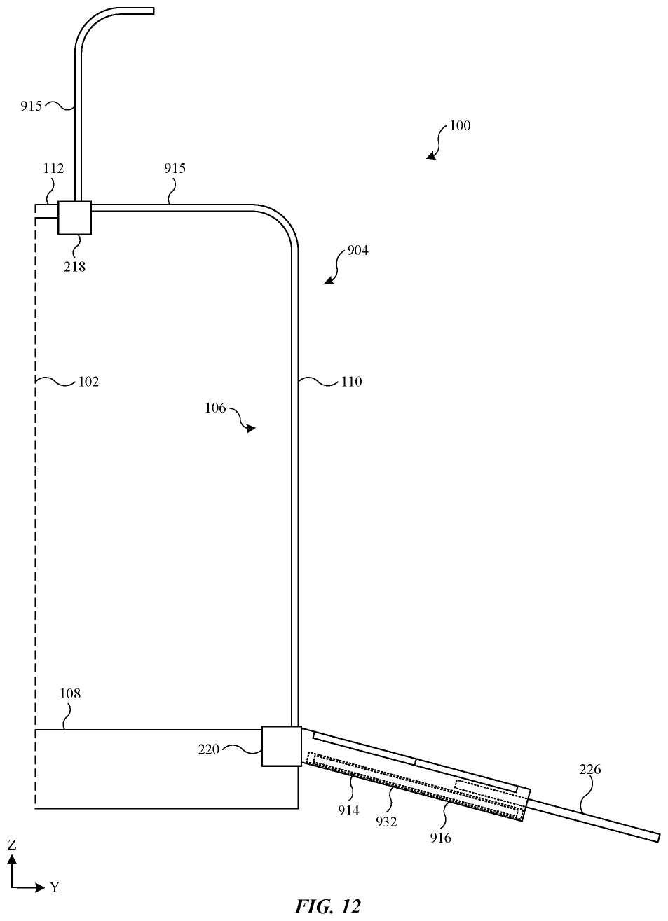

FIG. 9 is a schematic cross-section illustration that shows an alternative implementation of a closure assembly 904 for the vehicle 100, with the closure assembly 904 in a closed position. The closure assembly 904 replaces the window 214 with a side window portion 914 and a movable roof portion 915 and replaces the door 216 with a door 916. The door 916 includes the stairway assembly 222 and the movable ramp 226. FIG. 10 shows the side window portion in an open position, while the movable roof portion 915 and the door 916 are in the closed position. FIG. 11 shows the side window portion 914, the movable roof portion 915, and the door 916 in an open position, with the stairway assembly 222 in the deployed position. FIG. 12 shows the side window portion 914, the movable roof portion 915, and the door 916 in an open position, with the movable ramp 226 in the deployed position.

The movable roof portion 915 is an opaque or see-through (e.g., transparent or translucent) panel that is connected to the vehicle body 102 by the first movement mechanism 218 and is moved between a closed position (FIGS. 9-10) and an open position (FIGS. 11-12) in the manner previously described with respect to the window 214, for example, by pivoting of the movable roof portion 915 upward and inward by the first movement mechanism 218.

Alternatively, the movable roof portion 915 may be slidable in the longitudinal direction X of the vehicle 100 in the manner described with respect to sliding of the window 214 using the linkage 719 and the track 828 of FIGS. 7-8.

The door 916 of the closure assembly is implemented in the manner described with respect to the door 216 except that a window mechanism 932 is located in the door 916, connects the side window portion 914 to the door 916, and supports the side window portion 914 for movement with respect to the door 916 for movement between a raised position (FIG. 9) and a lowered position, as shown in FIG. 10. In the raised position, at least part of the side window portion 914 is located above the door 916 and is positioned in the opening 106. In the lowered position, the side window portion 914 has fully or partly been moved into the door 916 by the window mechanism 932, which may be implemented using conventional window lowering and raising hardware configurations.

With the side window portion 914 in the open position, and optionally with the movable roof portion 915 in the open position, the door 916 may be moved to the open position as previously described with respect to the door 216. When the door 916 is in the open position, the stairway assembly 222 may be moved from the stowed position to the deployed position, as shown in FIG. 11, in which the stairway assembly 222 is in the deployed position. When the door 916 is in the open position, the movable ramp 226 may be moved from the stowed position to the deployed position, as shown in FIG. 12, in which the movable ramp 226 is in the deployed position. Thus, in the current example, either of the stairway assembly 222 or the movable ramp 226 may be moved from the stowed position to the deployed position while the door 916 is in the open position, according to a selection made by a user or by an automated system of the vehicle 100.

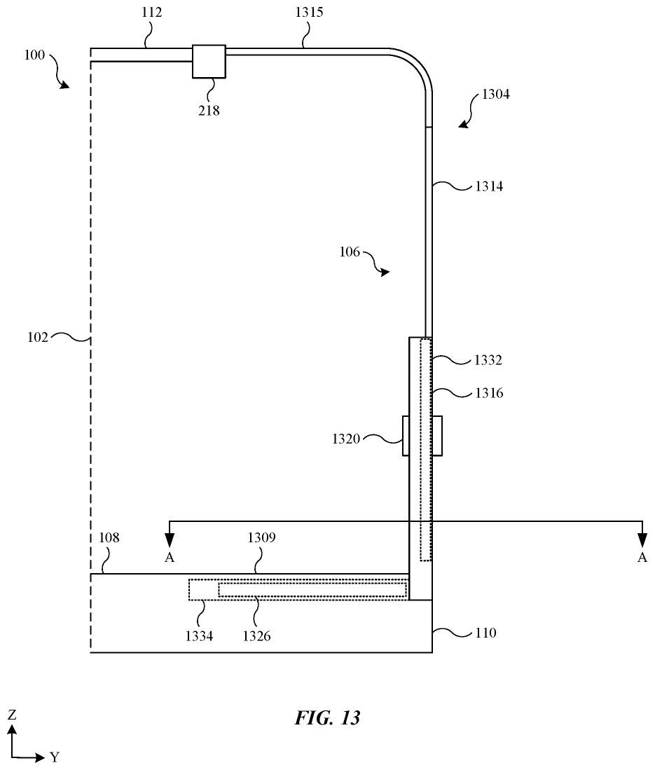

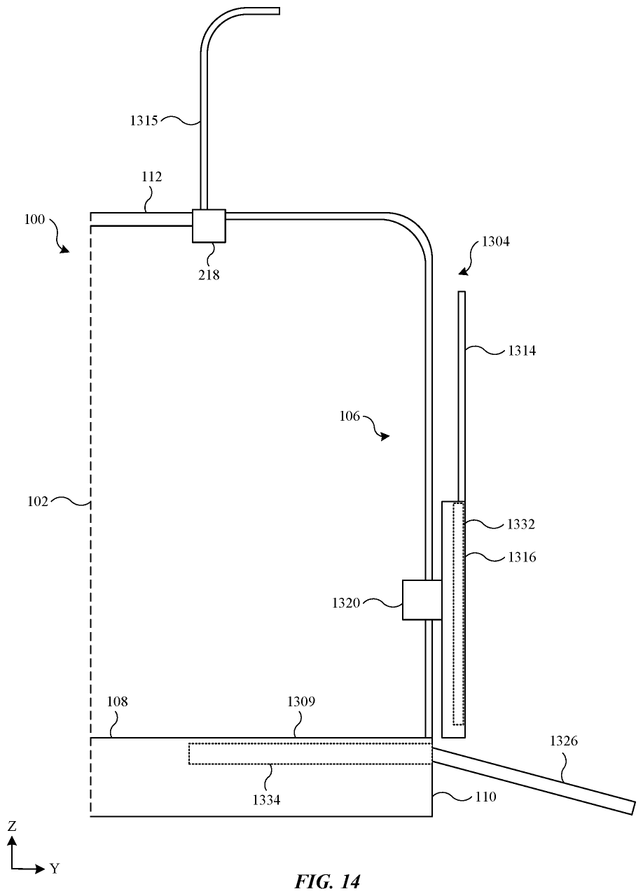

FIG. 13 is a schematic cross-section illustration that shows an alternative implementation of a closure assembly 1304 for the vehicle 100, with the closure assembly 1304 in a closed position, and FIG. 14 shows the closure assembly 1304 in an open position. The closure assembly 1304 includes a side window portion 1314, a movable roof portion 1315, a door 1316, and a window mechanism 1332 that connects the side window portion 1314 to the door 1316 and supports the side window portion 1314 for movement with respect to the door 1316 for movement between a raised position (FIG. 9) and a lowered position (FIG. 10). These components are implemented in the manner described with respect to the side window portion 914, the movable roof portion 915, the door 916, and the window mechanism 932 except as described to the contrary herein.

The movable roof portion 1315 is supported by the first movement mechanism 218 and may pivot upward and inward from the closed position (FIG. 13) to the open position (FIG. 14). The door 1316 and the side window portion 1314 are connected to the vehicle body 102 by a slide assembly 1320 that is configured to move the door 1316 and the side window portion 1314 between the closed position (FIG. 13) and the open position (FIG. 14). As an example, the slide assembly 1320 may be connected to and supported by the side portion 110 of the vehicle body 102 and/or by other portions of the vehicle body 102. The slide assembly 1320 may be implemented using conventional vehicle sliding door hardware configurations. To move the door 1316 from the closed position to the open position, the slide assembly 1320 may be configured to move the door 1316 away from the opening 106 of the vehicle body 102 by first translating the door 1316 in the lateral direction Y of the vehicle 100, and then translating the door 1316 in the longitudinal direction X of the vehicle so that the door 1316 is no longer positioned in front of the opening 106. The door 1316 may be moved between the closed position and the open position with the side window portion 1314 in its closed or open positions.

The closure assembly 1304 includes a movable ramp 1326 that is connected to the vehicle body 102. The configuration of the movable ramp 1326 is similar to that of the movable ramp 226, except that the movable ramp 1326 is not directly connected to the door 1316. The movable ramp 1326 is movable between a stowed position (FIG. 13) and a deployed position (FIG. 14). In the illustrated implementation, the movable ramp 1326 is located inside a housing 1334 in the stowed position. The housing 1334 is located inside the vehicle body 102, in the floor portion 108, and may be located under a floor surface 1309 that is defined by the floor portion 108 of the vehicle body 102. The movable ramp 1326 includes actuators that are configured to cause movement of the movable ramp 1326 between the stowed position and the deployed position. Movement of the movable ramp 1326 from the stowed position to the deployed position may include translation of the movable ramp 1326 outward relative to the vehicle body 102 in the lateral direction Y, and pivoting of the movable ramp 1326 downward relative to the vehicle body 102 toward an underlying surface, such as a road surface or a ground surface. Thus, the movable ramp 1326 extends outward from the vehicle body 102 and is angled downward relative to the floor portion 108 of the vehicle body 102 when the movable ramp 1326 is in the deployed position.

Movement of the movable ramp 1326 from the stowed position to the deployed position may be coordinated with movement of the door 1316 from the closed position to the open position. Movement of the movable ramp 1326 and the door 1316 may occur in a first motion phase, a second motion phase, and a third motion phase. Coordinating movement of the movable ramp 1326 and the door 1316 may avoid defining a gap between the vehicle body 102 and the door 1316 as the door 1316 translates outward relative to the vehicle body 102 in the lateral direction Y of the vehicle body 102 prior to translating in the longitudinal direction X.

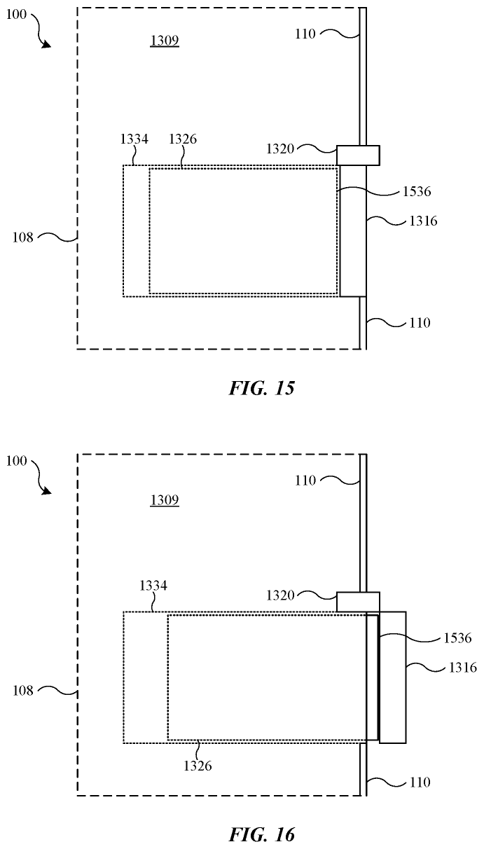

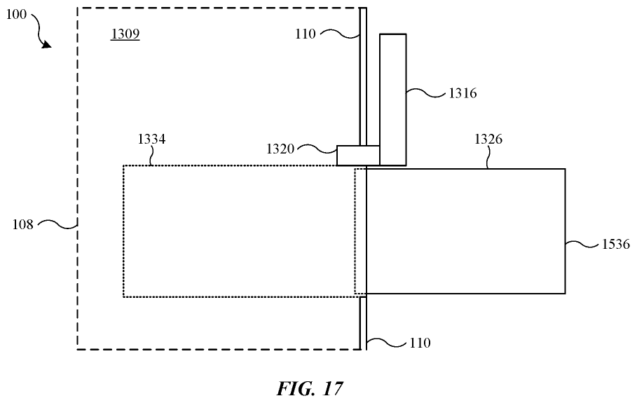

FIG. 15 is a schematic cross-section illustration taken along line A-A of FIG. 13 showing the door 1316 and the movable ramp 1326 prior to a first motion phase. FIG. 16 is a schematic cross-section illustration taken along line A-A of FIG. 13 showing the door 1316 and the movable ramp 1326 prior to a second motion phase and a third motion phase. FIG. 17 is a schematic cross-section illustration taken along line A-A of FIG. 13 showing the door 1316 and the movable ramp 1326 subsequent to the second motion phase and the third motion phase.

As shown in FIG. 15, the door 1316 is initially in the closed position and the movable ramp 1326 is initially in the stowed position, located in the housing 1334 below the floor surface 1309. As shown in FIG. 16, in the first motion phase, while the door 1316 moves outward from the opening 106 of the vehicle body 102 in the lateral direction Y, the movable ramp 1326 moves outward relative to the vehicle body 102 in correspondence with movement of the door 1316. During this outward movement of the door 1316 and the movable ramp 1326 during the first motion phase, an outer end 1536 of the movable ramp 1326 is positioned adjacent to the door 1316. As an examples, the outer end 1536 of the movable ramp 1326 may be in engagement with the door 1316 during outward movement of the movable ramp 1326 and the door 1316. As an example, the outer end 1536 of the movable ramp 1326 may be positioned so that a small gap (e.g., fifty millimeters or less) is defined between the outer end 1536 of the movable ramp 1326 and the door 1316 during outward movement of the movable ramp 1326 and the door 1316. As shown in FIG. 17, in the second motion phase, the door 1316 translates in the longitudinal direction X of the vehicle body 102 after moving out of the opening 106 so that the door 1316 is no longer positioned in front of the opening 106. After the door 1316 has translated longitudinally away from the opening 106, in the third motion phase, the movable ramp 1326 continues movement toward the deployed position by translating outward and pivoting downward, as previously described.

In this implementation, the movable ramp 1326 is shown as a one-piece structure. It should be understood, however, the movable ramp 1326 may include multiple sections that are connected to each other for relative motion, such as by sliding connections or telescoping connections. As one example, the movable ramp 1326 may include first and second portions, where the first portion (and optionally the second portion) move outward with the door 1316 during the initial movement of the door 1316, while the first portion remains fixed in place after the door 1316 translates out of the opening 106 and the second portion of the movable ramp 1326 moves further outward and/or pivots downward relative to the first portion of the movable ramp 1326.

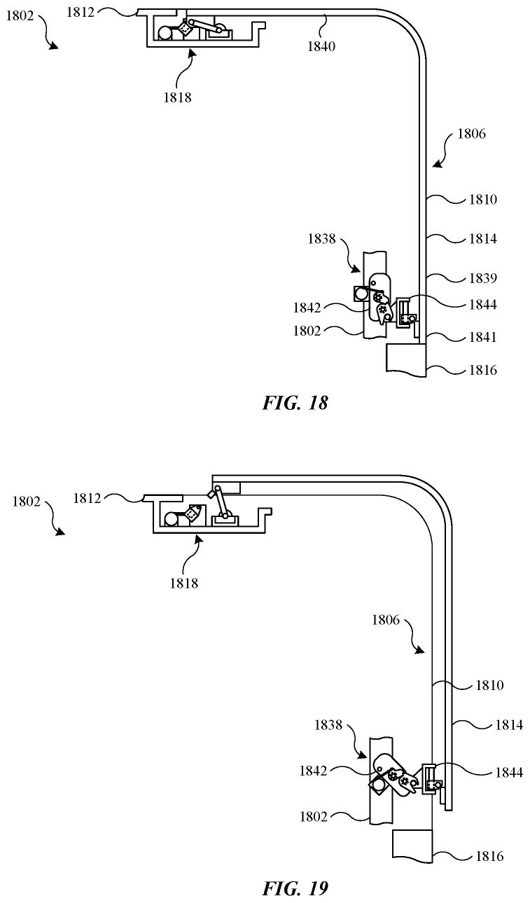

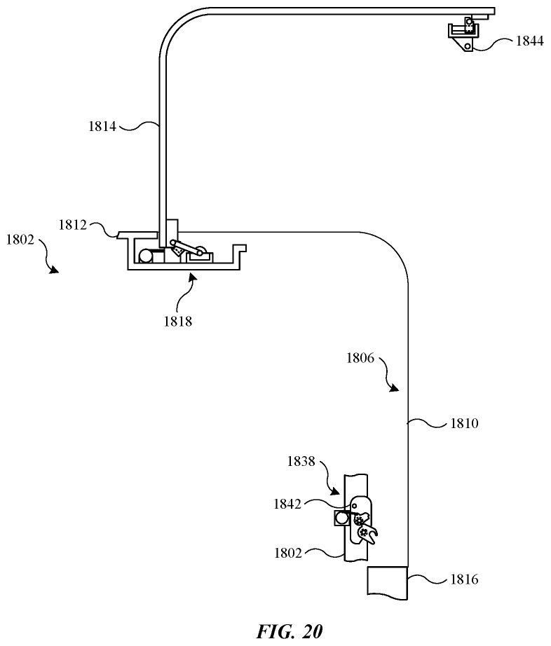

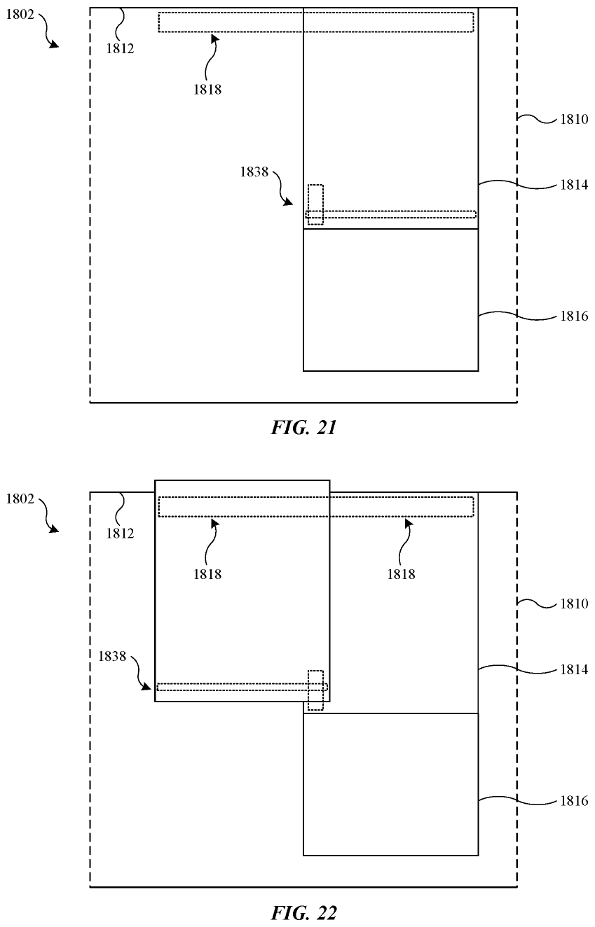

FIGS. 18-20 are front cross-section illustrations that show an upper closure panel, such as a window 1814, that is connected to a vehicle body 1802 by a movement mechanism 1818 and a sliding latch assembly 1838. FIGS. 21-22 are side view illustrations of the window 1814. The window 1814 is movable between a closed position (FIG. 18 and FIG. 21), a first open position (FIG. 19 and FIG. 22), in which the window 1814 has been moved outward relative to the vehicle body 1802, and a second open position (FIG. 20), in which the window 1814 has been pivoted upward and inward relative to the vehicle body 1802. The window 1814, the movement mechanism 1818, the sliding latch assembly 1838, and other supporting components that are described herein may be implemented in the context of the vehicle 100, for example, in place of the window 214 and the first movement mechanism 218. The features and components previously described with respect to the vehicle body 102 may be used as a basis for implementing features and components of this implementation, and/or may be used in conjunction with this implementation.

The window 1814 is consistent with the description of the window 214, except as stated to the contrary herein. The window 1814 may include a transition (e.g., angled or curved) between a first part 1839 (e.g., a lower part) of the window 1814 that extends primarily in the elevational direction Z in the area adjacent to the side portion 1810 of the vehicle body 1802 and a second part 1840 (e.g., an upper part) of the window 1814 that extends primarily in the transverse direction Y adjacent to the roof portion 1812 of the vehicle body 1802. In the illustrated implementation, a lower end 1841 of the window 1814 is positioned adjacent to a lower closure panel, such as a door 1816, which may be implemented in the manner described with respect to the door 216.

The movement mechanism 1818 is connected to a roof portion 1812 of the vehicle body 1802. Thus, the movement mechanism 1818 connects the window 1814 to the roof portion 1812 of the vehicle body 1802 for movement with respect to the vehicle body 1802 between the closed position, the first open position, and the second open position. The movement mechanism 1818 is configured to selectively translate or pivot the window 1814. The configuration of the movement mechanism 1818 will be described further herein.

The sliding latch assembly 1838 includes a first latch part 1842 and a second latch part 1844. The first latch part 1842 is connected to the vehicle body 1802. As an example, the first latch part 1842 may be connected to the vehicle body 1802 on or near the side portion 1810 of the vehicle body 102 adjacent to the opening 1806. In the closed position, the window 1814 is positioned in front of the first latch part 1842 so that the first latch part 1842 is not exposed from the exterior. The second latch part is connected to the window 1814 near the lower end 1841 of the window 1814. The sliding latch assembly 1838 is movable between a latched position and an unlatched position. In the latched position (FIGS. 18-19 and FIG. 21), the first latch part 1842 is connected to the second latch part 1844. As will be described further herein, the sliding latch assembly 1838 is in the latched position when the window 1814 is in the closed position and when the window 1814 is in the first open position. To allow movement of the window 1814 from the closed position to the first open position, the sliding latch assembly 1838 is pivotable with respect to the vehicle body 1802 and permits sliding of the window 1814 with respect to part of the sliding latch assembly 1838 while remaining connected to the window 1814 by incorporation of a sliding joint in the sliding latch assembly 1838 as will be described further herein. In the unlatched position (FIG. 20 and FIG. 22), the first latch part 1842 is disconnected from the second latch part 1844. This allows the window 1814 to be pivoted away from the first latch part 1842 while the second latch part 1844 remains connected to the window 1814.

In the closed position (FIGS. 18 and 21), the window 1814 is located in an opening 1806 of the vehicle body 1802. A lower closure panel, such as a door 1816, may also be located in opening 1806, positioned below the window 1814. Together, the window 1814 and the door 1816 may fully occupy the opening 1806 in the closed position. In the closed position, the lower part of the window 1814 may be generally coincident with the side portion 1810 of the vehicle body 1802, and the upper part of the window 1814 may be generally coincident with the roof portion 1812 of the vehicle body 1802. In the first closed position, the sliding latch assembly 1838 is in the latched position, thereby securing the window 1814 to the vehicle body 1802 near the lower end 1841 of the window 1814.

In the first open position (FIG. 19 and FIG. 22), the window 1814 has been translated outward and upward relative to the vehicle body 1802, for example, in the lateral direction Y and the elevational direction Z of the vehicle body 1802, by the movement mechanism 1818. The distance by which the window 1814 has been translated relative to the vehicle body 1802 in the first open position is sufficient to position the window 1814 outward relative to the side portion 1810 and the roof portion 1812 of the vehicle body 1802. This allows the window 1814 to translate by sliding, for example, in the longitudinal direction Z of the vehicle body 1802 without contacting the vehicle body 1802. Thus, in the first open position, the window 1814 may be translated away from the opening 1806 by the movement mechanism 1818, as shown in FIG. 22. In the first open position, the sliding latch assembly 1838 is in the latched position, thereby securing the window 1814 to the vehicle body 1802 near the lower end 1841 of the window 1814. The sliding latch assembly 1838 is configured to permit the outward and upward translation of the window 1814 from the closed position to the first open position, for example, by pivoting with respect to the vehicle body 1802. While in the first open position, part of the sliding latch assembly 1838 is configured to allow sliding motion of the window 1814, as will be described further herein.

In the second open position (FIG. 20), the window 1814 has been pivoted relative to the vehicle body 1802 by the movement mechanism 1818, for example, by rotation of the window 1814 around an axis that is generally in alignment with the longitudinal direction X of the vehicle body 1802 (e.g., including misalignment by less that forty-five degrees). As an example, the window 1814 may be pivoted through an arc of approximately 90 degrees during movement from the closed position to the second open position. Pivoting of the window 1814 by the movement mechanism 1818 will be described further herein.

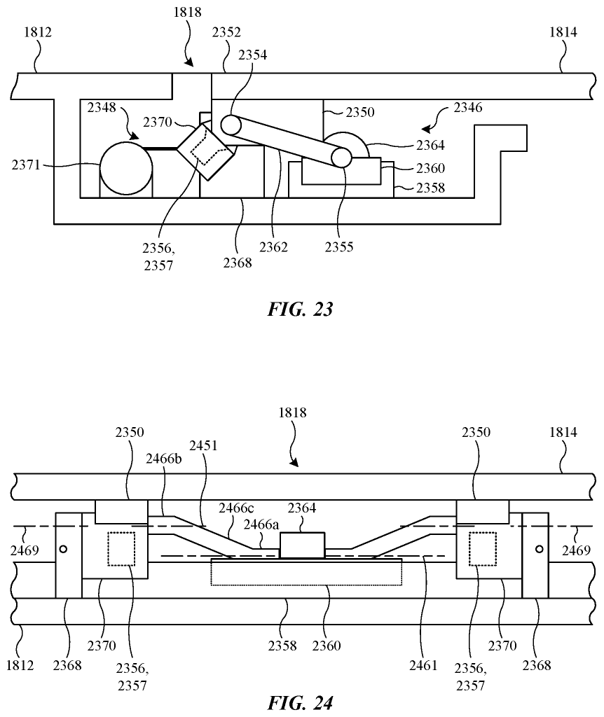

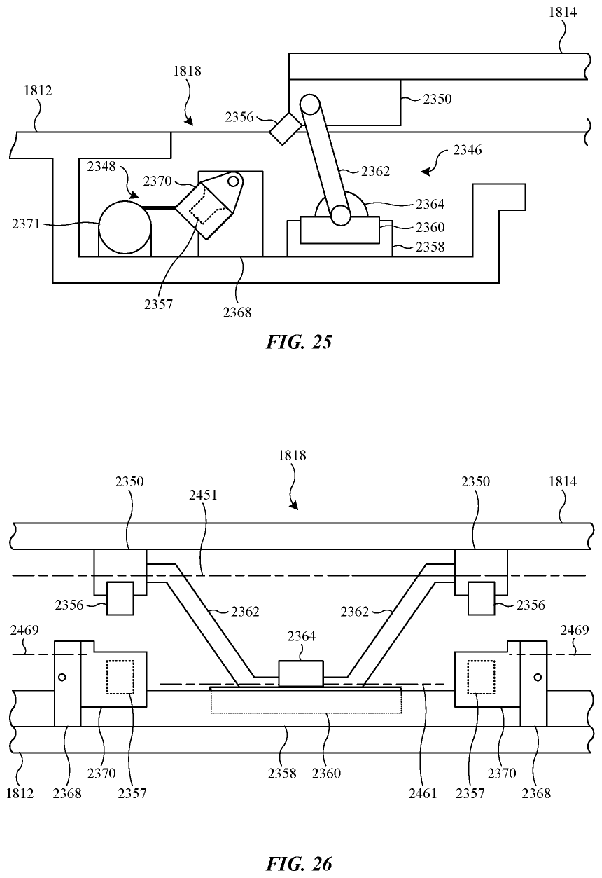

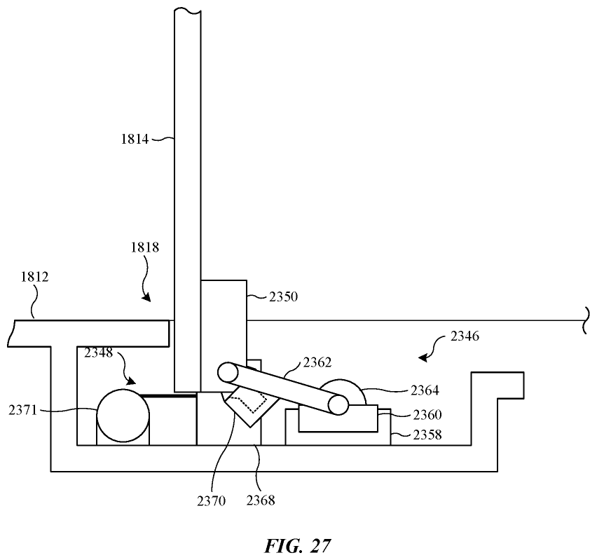

FIGS. 23-27 are illustrations that show the movement mechanism 1818. FIG. 23 is a front cross-section illustration of the movement mechanism 1818 with the window 1814 in the closed position. FIG. 24 is a side cross-section illustration of the movement mechanism 1818 with the window 1814 in the closed position. FIG. 25 is a front cross-section illustration of the movement mechanism 1818 with the window 1814 in the first open position. FIG. 26 is a side cross-section illustration of the movement mechanism 1818 with the window 1814 in the first open position. FIG. 27 is a front cross-section illustration of the movement mechanism 1818 with the window 1814 in the second open position.

The movement mechanism 1818 is connected to the roof portion 1812 of the vehicle body 1802 and includes a first movement stage 2346 and a second movement stage 2348. The first movement stage 2346 is configured to move the window 1814 between the closed position and the first open position. The second movement stage 2348 is configured to move the window 1814 between the closed position and the second open position. As will be explained further herein, the second movement stage 2348 is configured to be disconnected from the window 1814 in order to allow translation of the window 1814 in the longitudinal direction X of the vehicle body 1802 by the first movement stage in the second open position of the window 1814.

A support structure 2350 is connected to the window 1814 near an upper end 2352 of the window 1814. The support structure 2350 may be fixed to the window 1814 by any suitable manner of attachment such as adhesives or fasteners. The support structure 2350 is configured to provide an attachment point for the first movement stage 2346 and the second movement stage 2348 with respect to the window 1814. To connect the support structure 2350 to the first movement stage 2346, the support structure 2350 includes a first pivot 2354 that is connected to a portion of the first movement stage 2346, as will be explained herein. To connect the support structure 2350 to the second movement stage 2348, the support structure 2350 includes a first coupler part 2356 that extends outward from the support structure 2350. The first coupler part 2356 is configured to connect to and disconnect from a second coupler part 2357 of the second movement stage 2348, as will be explained herein. In some implementations, the support structure 2350 is one of several similarly configured structures that have like components for connection to the first movement stage 2346 and the second movement stage 2348. In some implementations, the support structure 2350 includes multiple instances of the first pivot 2354 and multiple instances of the first coupler part 2356 for connection to the first movement stage 2346 and the second movement stage 2348.

In the illustrated implementation, the first movement stage 2346 includes a linear motion guide 2358, a carriage 2360, a crank 2362, and an actuator assembly 2364. The linear motion guide 2358 is any manner of structure that is configured to support the carriage 2360 for movement with respect to the vehicle body 1802 and constrain motion of the carriage 2360 to move along a path, such as a linear path that is generally aligned with the longitudinal direction X of the vehicle body 1802, such that it moves along an intended line of motion. As examples, the linear motion guide 2358 may be or include one or more tracks, one or more rails, one or more rods, or other suitable structures. The linear motion guide 2358 extends in the longitudinal direction X of the vehicle body 1802. The linear motion guide 2358 may be connected to the roof portion 1812 of the vehicle body 1802, or to another structure. The carriage 2360 may be implemented using any type of structure that is configured to move along the linear motion guide 2358, such as a linear bearing. The carriage 2360 is connected to the linear motion guide 2358 and moves along the linear motion guide 2358 in the longitudinal direction X of the vehicle body 1802 during translation of the window 1814 when the window 1814 is in the first open position.

The crank 2362 connects the carriage to 2360 the support structure 2350 so that rotation of the crank 2362 causes movement of the window 1814 with respect to the vehicle body 1802. As best seen in FIG. 24 and FIG. 26, The crank 2362 includes a first end portion 2466a, a second end portion 2466b, and an intermediate portion 2466c. The first end portion 2466a is connected to the carriage 2360 by the second pivot 2355 and extends along a carriage axis 2461. The second end portion 2466b is connected to the support structure 2350 by the first pivot 2354 and extends along a support axis 2451. The intermediate portion 2466c extends from the first end portion 2466a of the crank 2362 and the second end portion 2466b of the crank 2362 and defines a radius for the crank 2362 according to the distance between the carriage axis 2461 and the support axis 2451.

The actuator assembly 2364 is configured to cause rotation of the crank 2362 with respect to the carriage 2360 and is also configured to cause movement of the carriage 2360 with respect to the linear motion guide 2358. As examples, the actuator assembly 2364 may include one or more electric motors, pneumatic actuators, hydraulic actuators, or other powered devices that are configured to cause motion. In the illustrated implementation, the actuator assembly 2364 is shown as being located on the carriage 2360. The actuator assembly 2364 could alternatively or additionally include components that are not located on the carriage 2360, such as motors that are connected to the crank 2362 and/or the carriage 2360 by conventional structures such as cables.

Starting from the closed position (FIGS. 23-24), the first movement stage 2346 causes movement of the window 1814 to the first open position bye rotation of the crank 2362 using the actuator assembly 2364. The crank 2362 is rotated in the clockwise direction relative to the position shown in FIG. 23 in order to move towards the first open position from the closed position. The center of rotation of the crank 2362 is along the carriage axis 2461. Thus, as the crank 2362 rotates, the location of the support axis 2451 is moved by the crank 2362 according to a circular arc that is centered on the carriage axis 2461, and this causes a corresponding movement of the support structure 2350 and the window 1814 along the same circular arc. During rotation of the crank 2362, the second end portion 2466b of the crank 2362 rotates with respect to the support structure 2350, but the rotational orientation of the window 1814 is constrained by connection of the window 1814 to the vehicle body 1802 by the sliding latch assembly 1838 as previously described. Rotation of the crank 2362 continues until reaching the first open position (FIGS. 25-26). The window 1814 is returned to the closed position by opposite rotation of the crank 2362.

Movement of the window 1814 from the closed position to the first open position causes a corresponding movement of the first coupler part 2356, thereby moving the first coupler part 2356 from a connected position to a disconnected position relative to the second coupler part 2357 of the second movement stage 2348. As an example, the first coupler part 2356 may include a beam that extends outward from the support structure 2350, for example, in a direction that is generally perpendicular to the support axis 2451, and the second coupler part 2357 may include a corresponding recess. In this example implementation, the beam is located inside the recess when the first coupler part 2356 and the second coupler part 2357 are in the connected position and the beam is located outside of the recess when the first coupler part 2356 and the second coupler part 2357 are in the disconnected position.

When the first coupler part 2356 is in the connected position relative to the second coupler part 2357, the connection of the window 1814 to the second movement stage 2348 restrains the window 1814 from translating in the longitudinal direction of the vehicle body 1802 along the linear motion guide 2358. Because the first coupler part 2356 is moved to the disconnected position relative to the second coupler part 2357 as a result of movement of the window 1814 to the first open position, the first movement stage 2346 is able to translate the window 1814 along the linear motion guide 2358 using the carriage 2360, because the window 1814 is not engaged with the second movement stage 2348.

The second movement stage 2348 includes a base portion 2368, a rotatable support 2370, and an actuator 2371. The base portion 2368 is a structure that supports the rotatable support 2370 so that it is able to rotate on a rotation axis 2469 in response to operation of the actuator 2371. The rotatable support 2370 is connected to the actuator 2371 through the base portion 2368. In the illustrated example, the actuator 2371 is connected to the base portion 2368 by a cable that drives rotational motion of the rotatable support 2370. The cable may be directly connected to the rotatable support 2370 or may be connected to the rotatable support 2370 through an intermediate structure such as a gear train. Other types of connections may be used as alternatives to the cable. As examples, the actuator 2371 may be directly connected to the rotatable support 2370, or maybe connected to the rotatable support 2370 by a linkage or other suitable connecting structure. The rotatable support 2370 includes the second coupler part 2357, which is a recess in the illustrated implementation. When the first coupler part 2356 is in the connected position with respect to the second coupler part 2357, the first coupler part may be located inside the rotatable support 2370, as in the illustrated implementation.

Starting from the closed position (FIGS. 23-24), the sliding latch assembly 1838 is moved from the connected position to the disconnected position prior to movement of the window 1814 toward the second open position. Next, with the first coupler part 2356 in the connected position with respect to the second coupler part 2357, the window 1814 is moved from the closed position toward the second open position by operation of the actuator 2371 to cause rotation of the rotatable support 2370. As the rotatable support 2370 rotates around the rotation axis 2469, the connection of the rotatable support 2370 to the support structure 2350 causes corresponding rotation of the window 1814 around the support axis 2451, which is aligned with the rotation axis 2469 of the rotatable support 2370 when the first coupler part 2356 is in the connected position with respect to the second coupler part 2357. Rotation of the rotatable support 2370 may continue until the window 1814 reaches the second open position (FIG. 27). The window 1814 is returned to the closed position by opposite rotation of the rotatable support 2370.

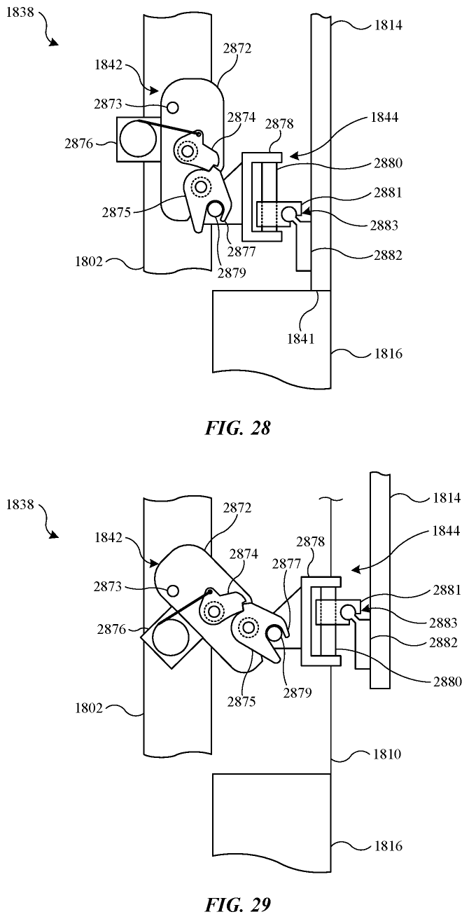

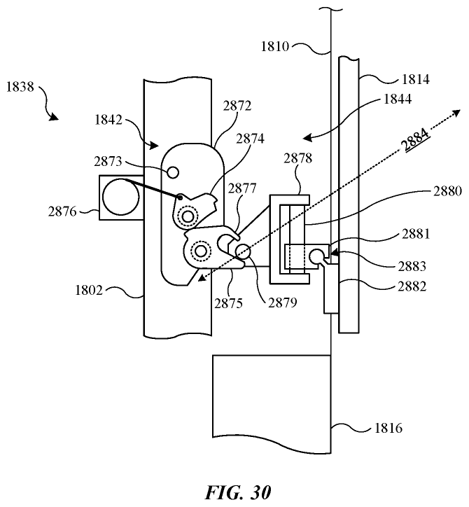

FIGS. 28-30 show the sliding latch assembly 1838, which is movable between a latched position and an unlatched position that correspond to engagement and disengagement of the first latch part 1842 and the second latch part 1844. FIG. 28 is a schematic cross section illustration showing the sliding latch assembly 1838 in the latched position with the window 1814 in the closed position. FIG. 29 is a schematic cross section illustration showing the sliding latch assembly 1838 in the latched position with the window 1814 in the first open position. FIG. 30 is a schematic cross section illustration showing the sliding latch assembly 1838 in the unlatched position with the window 1814 moving between the closed position and the second open position.

The first latch part 1842 of the sliding latch assembly 1838 is connected to the vehicle body 1802. The first latch part 1842 includes a frame 2872 a frame pivot 2873, a pawl 2874, a latch member 2875, and an actuator 2876.

The frame 2872 is any type of structure that serves to support and interconnect other portions of the first latch part 1842. The first latch part 1842 is connected to the vehicle body 1802 in a manner that allows pivoting of the first latch part 1842 with respect to the vehicle body 1802, for example by pivotal connection of the frame 2872 to the vehicle body 1802 by the frame pivot 2873, which may be a pivot joint of any type. The frame 2872 may be biased toward a rest position (e.g., as shown in FIG. 28) in which the frame 2872 does not move unless acted upon, for example, by biased engagement of the frame 2872. As an example, the frame 2872 may be biased into engagement with a mechanical stop (e.g., formed on the vehicle body 1802) in the rest position.

The pawl 2874 is pivotally connected to the frame 2872, for example, by a pivot joint, and is biased for rotation toward the latch member 2875 (e.g., clockwise in FIGS. 28-30) by a spring or other suitable biasing element. The latch member 2875 is pivotally connected to the frame 2872, for example, by a pivot joint, and is biased for rotation toward the pawl (e.g., counter clockwise in FIGS. 28-30) by a spring or other suitable biasing element. The latch member 2875 includes an engaging feature, such as a hook 2877, that is configured to establish and maintain engagement with the second latch part 1844 in the latched position, as will be described herein.

In the latched position (FIGS. 28-29), engagement of the pawl 2874 with the latch member 2875 prevents rotation of the latch member 2875 and thereby maintains engagement of the first latch part 1842 with the second latch part 1844 to keep the sliding latch assembly 1838 in the latched position. This may be referred to as an engaged position of the pawl with respect to the latch member 2875. To move the sliding latch assembly 1838 from the latched position to the unlatched position, the actuator 2876 is operably connected to the pawl 2874 (e.g., by a direct connection, a cable, a lever, or gears) to cause rotation of the pawl 2874 away from the latch member 2875 (e.g., counter clockwise as illustrated) and in opposition to the biasing force. The actuator 2876 may be any suitable type of powered actuator component, such as an electric motor. This may be referred to as a disengaged position of the pawl 2874, in which the pawl 2874 does not restrain rotation of the latch member 2875, and permits movement of the sliding latch assembly 1838 from the engaged position to the disengaged position by rotation of the latch member 2875 so that it no longer retains the second latch part 1844.

The second latch part 1844 of the sliding latch assembly 1838 is connected to the window 1814. The second latch part 1844 includes a frame 2878, a striker 2879, a support pin 2880, a slide member 2881, and a guide member 2882. A sliding joint 2883 is defined by the slide member 2881 and the guide member 2882.

The frame 2878 is a component that supports and interconnects the striker 2879 and the support pin 2880. The striker 2879 is a structural feature of the second latch part 1844, such as a rigid, large diameter, wire-like structure, that functions to engage the latch member 2875 of the first latch part 1842 to establish the latched position. The latch member 2875 is connected to the striker 2879 in the latched position, and the latch member 2875 is disconnected from the striker 2879 in the unlatched position.

In the illustrated implementation, the striker 2879 extends generally in the longitudinal direction X of the vehicle body 1802, but other orientations are possible. The support pin 2880 is configured to connect the slide member 2881 to the frame 2878 in a compliant manner to allow relative motion of the slide member 2881 and the frame 2878 as a result of movement of the sliding latch assembly 1838 when the window 1814 moves between the closed position and the first open position. In the illustrated implementation, the support pin 2880 extends in an upright direction (e.g., generally aligned with the elevational direction of the vehicle body 1802), and allows the slide member 2881 to slide up and down along the support pin 2880 as well as rotate around the support pin 2880.

The guide member 2882 is an elongate structure that is connected to the window 1814 (e.g., to an interior surface), and extends in a direction that is generally aligned with the longitudinal direction X of the vehicle body 1802. The guide member 2882 is any manner of structure that is configured to guide linear motion in a constrained manner. As examples, the guide member 2882 may be a rail, a track, or a rod. The slide member 2881 is a structure that is complementary to the guide member 2882 so that the slide member 2881 is configured to slide along the guide member 2882. The sliding joint 2883 is defined by a connection of the slide member 2881 to the guide member 2882 in a manner that allows the slide member 2881 to slide along the guide member 2882. The sliding joint 2883 functions to allow translation of the window 1814 with respect to the vehicle body 1802 when the sliding latch assembly 1838 is in the latched position and the window 1814 is in the first open position. The slide member 2881 and the guide member 2882 may also have circular cross sectional shapes at the sliding joint 2883 to allow pivoting of the slide member 2881 with respect to the guide member 2882 along an axis that is generally aligned with the longitudinal direction X of the vehicle body 1802.

When the window 1814 is in the closed position and the sliding latch assembly 1838 is in the latched position (FIG. 28), the pawl 2874 is in the rest position and in engagement with the latch member 2875. In this position, the hook 2877 of the latch member 2875 engages and retains the striker 2879 to maintain the first latch part 1842 in the latched position with respect to the second latch part 1844.

When the window 1814 is moved to the first open position by the movement mechanism 1818, the first latch part 1842 remains in the latched position with respect to the second latch part 1844 while the first latch part 1842 pivots with respect to the vehicle body 1802 around the frame pivot 2873 in response to movement of the second latch part 1844 with the window 1814 (FIG. 29). During movement from the closed position to the first open position, the slide member 2881 may pivot and/or translate along the support pin 2880 of the frame 2878 of the second latch part 1844, and the slide member 2881 may pivot and or translate with respect to the guide member 2882 at the sliding joint 2883. Once the window 1814 has been moved to the first open position, the movement mechanism 1818 can cause translation of the window 1814 in a direction that is generally aligned with the longitudinal direction X of the vehicle body 1802. During this translation of the window 1814 with respect to the vehicle body 1802, the window 1814 remains connected to the vehicle body 1802 by the sliding latch assembly 1838, and the window 1814 and the guide member 2882 slide with respect to the slide member 2881 at the sliding joint 2883.

In order to move the window 1814 to the second open position, the sliding latch assembly 1838 is moved to the unlatched position (FIG. 30). In particular, operation of the actuator 2876 causes rotation of the pawl 2874 so that the pawl 2874 rotates away from the latch member 2875 and disengages from the latch member 2875. Upon disengagement of the pawl 2874 from the latch member 2875, the latch member 2875 is able to rotate (clockwise as illustrated) so that the hook 2877 of the latch member 2875 is rotated so that it points outward toward the window 1814 in a direction that permits the striker 2879 to disengage and move away from the latch member 2875 upon movement of the window 1814. With the sliding latch assembly 1838 in the unlatched position, the window 1814 is able to move, for example, by rotation centered on a rotation axis of the movement mechanism 1818. This causes the striker 2879 to move along an arc 2884 that corresponds to the movement path of the window 1814. To return the sliding latch assembly 1838 to the latched position, the actuator 2876 is deactivated to allow the pawl 2874 to be biased toward the latch member 2875. The latch member 2875 remains rotated toward the pawl 2874 with the hook 2877 oriented outward toward the window 1814. As the window 1814 moves toward the first latch part 1842, the striker 2879 moves into engagement with the latch member 2875 adjacent to the hook 2877. Engagement of the striker 2879 with the latch member 2875 rotates the latch member 2875 (clockwise has illustrated) until me pawl 2874 is able to rotate into engagement with a complementary feature on the latch member 2875, at which point the pawl 2874 once again restrains the latch member from rotating toward the pawl 2874, which establishes the latched position and maintains the first latch part 1842 in engagement with the second latch part 1844.

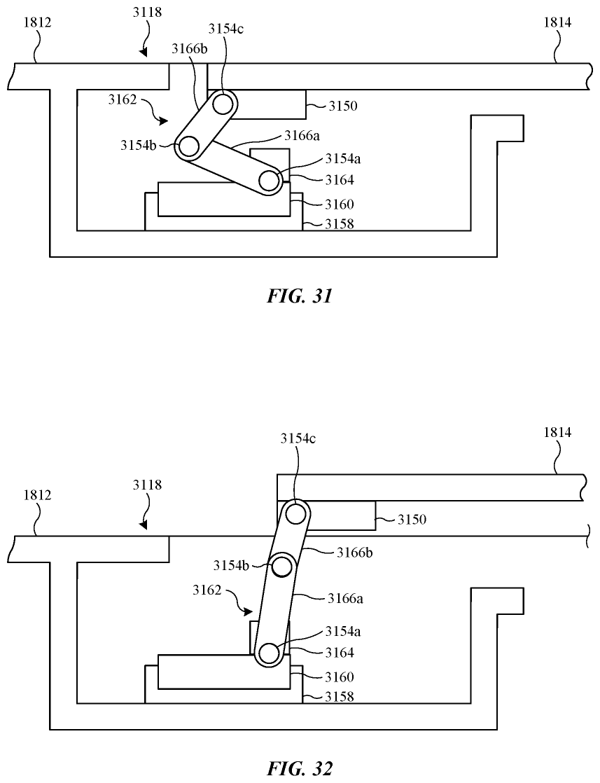

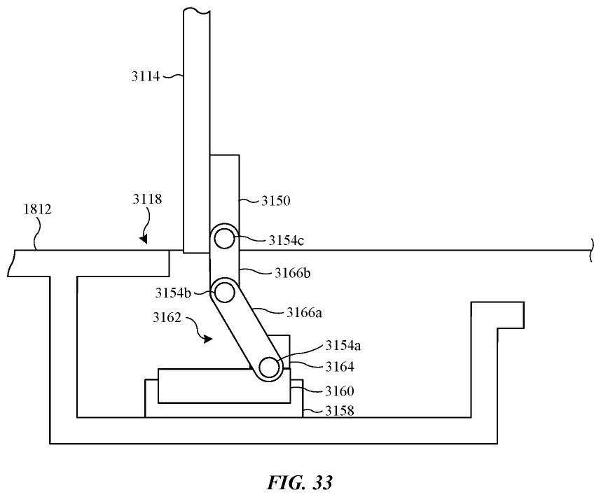

FIGS. 31-33 show a movement mechanism 3118 according to an alternative implementation that can be used with the upper closure panel (e.g., the window 1814) in place of other movement mechanisms, such as the first movement mechanism 218 and the movement mechanism 1818. The movement mechanism 3118 is configured to move the window 1814 between the closed position, the first open position, and the second open position, which are as previously described. FIG. 31 is a front cross-section illustration of the movement mechanism 3118 with the window 1814 in the closed position. FIG. 32 is a front cross-section illustration of the movement mechanism 1818 with the window 1814 in the first open position. FIG. 33 is a front cross-section illustration of the movement mechanism 1818 with the window 1814 in the second open position.

The window 1814 is supported by a support structure 3150, which is equivalent to the support structure 2350, as previously described. The movement mechanism 3118 includes a linear motion guide 3158 and a carriage 3160, which are equivalent to the linear motion guide 2358 and the carriage 2360, as previously described. The movement mechanism 3118 includes a linkage 3162 that is connected to the carriage 3160 and is connected to the support structure 3150 for supporting the support structure 3150 and the window 1814 with respect to the vehicle body 1802 during movement of the window 1814 between the closed position, the first open position, and the second open position. The movement mechanism 3118 also includes an actuator assembly 3164 (e.g., including one or more actuators and operative connections to actuated components) that is configured to cause motion of the window 1814 using the linkage 3162 and the support structure 3150, and is also configured to cause movement of the carriage 3160 along the linear motion guide 3158 to translate the window 1814 with respect to the vehicle body 1802 in a direction that is generally aligned with the longitudinal direction X of the vehicle body 1802. The actuator assembly 3164 may be implemented in the manner described with respect to the actuator assembly 2364.

The linkage 3162 extends from the carriage 3160 to the support structure 3150 and is configured to support the window 1814 at various positions. In the illustrated implementation, the linkage 3162 includes a first link 3166a and a second link 3166b. The first link 3166a is connected to the carriage 3160 by a first pivot joint 3154a, the first link 3166a is connected to the second link 3166b by a second pivot joint 3154b, and the second link is connected to the support structure 3150 by a third pivot joint 3154c. Relative motion of the first link 3166a, the second link 3166b, and the support structure 3150 is either directly or indirectly controlled by the actuator assembly 3164. As an example, the first link 3166a and the second link 3166b may be directly connected to an actuator or the actuator assembly 3164, or may be indirectly connected to an actuator of the actuator assembly 3164 by gears, cables, rods, linkages, or other conventional components used to transfer forces in actuator systems. In this manner, the actuator assembly 3164 is configured to cause rotation of the first link 3166a with respect to the carriage 3160 at the first pivot joint 3154a, the actuator assembly 3164 is configured to cause rotation of the second link 3166b with respect to the first link 3166a at the second pivot joint 3154b, and the actuator assembly 3164 is configured to cause rotation of the support structure 3150 and the window 1814 with respect to the second link 3166b at the third pivot joint 3154c. By moving the linkage 3162 to predetermined positions, the actuator assembly 3164 causes the window 1814 to move between the closed position, the first open position, and the second open position.

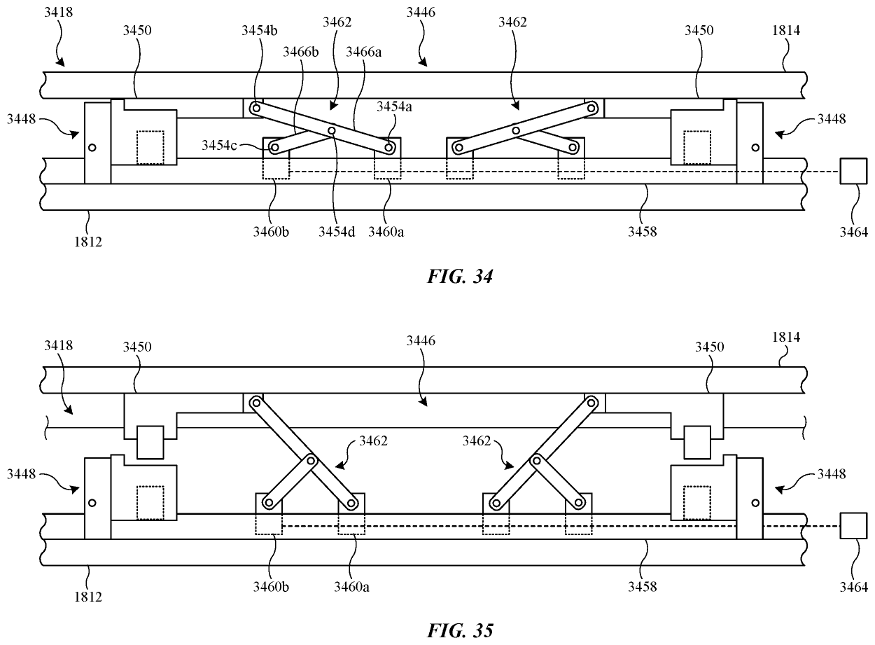

FIGS. 34-35 show a movement mechanism 3418 according to an alternative implementation that can be used with the upper closure panel (e.g., the window 1814) in place of other movement mechanisms, such as the first movement mechanism 218 and the movement mechanism 1818. FIG. 34 is a side cross-section illustration of the movement mechanism 3418 with the window 1814 in the closed position. FIG. 35 is a side cross-section illustration of the movement mechanism 3418 with the window 1814 in the first open position. The movement mechanism 3418 includes a first movement stage 3446 and a second movement stage 3448 that are configured to move the window 1814 between the closed position, the first open position, and the second open position, and function in a manner that is equivalent to the first movement stage 2346 and the second movement stage 2348 of the movement mechanism 1818. The first movement stage 3446 differs from the first movement stage 2346 of the movement mechanism 1818 and will be described further herein. The second movement stage 3448 may be implemented in the same manner as described with respect to the second movement stage 2348 of the movement mechanism 1818. A support structure 3450 is connected to the window 1814 and functions in the manner described with respect to the support structure 2350, including by connecting the window 1814 to the second movement stage 3448 when the window 1814 is in the closed position and in the second open position, and disconnecting the window 1814 from the second movement stage 3448 when the window 1814 is in the first open position.

The movement mechanism 3418 includes a linear motion guide 3458, which is similar to the linear motion guide 2358. The movement mechanism 3418 also includes a linkage 3462, a first carriage part 3460a, and a second carriage part 3460b. The first carriage part 3460a and the second carriage part 3460b are movable along the linear motion guide 3458, such as by sliding or rolling. The first carriage part 3460a and the second carriage part 3460b are connected to the linkage 3162. The linkage 3462 includes a first link 3466a and a second link 3466b. The first link 3466a extends from the first carriage part 3460a to the support structure 3450. The first link 3466a is connected to the first carriage part 3460a by a first pivot joint 3454a and is connected to the support structure 3450 by a second pivot joint 3454b. The second link 3466b extends from the second carriage part 3460b to the first link 3466a. The second link 3466b is connected to the second carriage part 3460b by a third pivot joint 3454c and is connected to the second link 3466b by a fourth pivot joint 3454d. This configuration causes the support structure 3450 to raise when the first carriage part 3460a and the second carriage part 3460b move toward each other, and to lower when the first carriage part 3460a and the second carriage part 3460b move away from each other.

The first carriage part 3460a and the second carriage part 3460b may be moved relative to one another along the linear motion guide 3458 or maybe moved in unison along the linear motion guide 3458. The movement mechanism 3418 includes an actuator assembly 3464 (e.g., including one or more actuators and operative connections to actuated components) that is configured to cause motion of the window 1814 using the linkage 3462, the support structure 3450, the first carriage part 3460a and the second carriage part 3460b, both in the elevational direction Z and the longitudinal direction Y. As an example, the actuator assembly 3464 may include one or more electric motors and cables that are configured to move the first carriage part 3460a and the second carriage part 3460b either relative to one another or in unison.

Movement of the first carriage part 3460a and the second carriage part 3460b relative to one another by the actuator assembly 3464 causes the window 1814 to raise or lower in the elevational direction Z of the vehicle body 1802 according to the configuration of the linkage 3462. This allows the first movement stage 3446 to move the window 1814 from the closed position (FIG. 34) to the open position (FIG. 35). Movement of the first carriage part 3460a and the second carriage part 3460b in unison by the actuator assembly 3464 causes the window 1814 to translate along the linear motion guide 3458 in the longitudinal direction X of the vehicle body 1802 when the window 1814 is in the first open position. From the closed position, the window 1814 can be moved to the second open position by the second movement stage 3448 in the same manner as described with respect to the second movement stage 2348 and as shown in FIG. 27.

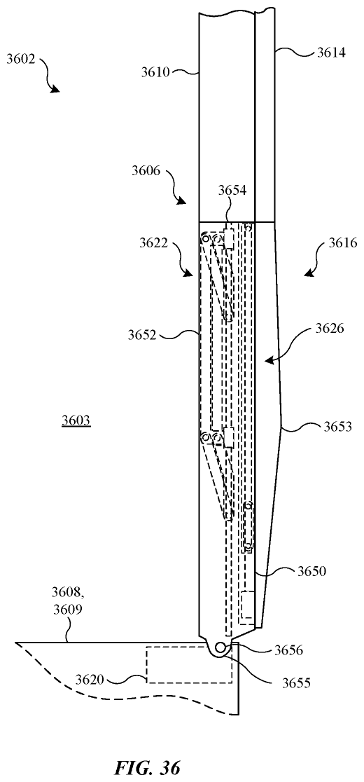

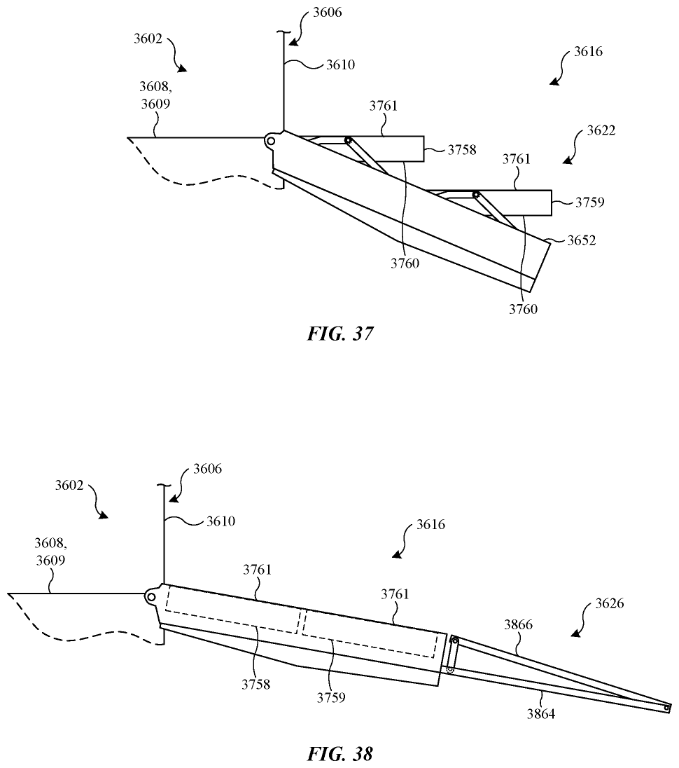

FIGS. 36-38 are front cross-section illustrations that show a lower closure panel, such as a door 3616, that is connected to a vehicle body 3602 by a movement mechanism 3620. An upper closure panel, such as a window 3614, is also shown. The door 3616 is connected to the vehicle body 3602 for movement between a closed position (FIG. 36), and an open position (FIGS. 37-38) relative to an opening 3606 that is formed in the vehicle body 3602. A stairway assembly 3622 is connected to the door 3616 and is configured to move between a stowed position (FIG. 36) and a deployed position (FIG. 37). A movable ramp 3626 is connected to the door 3616 and is configured to move between a stowed position (FIG. 36) and a deployed position (FIG. 38). The components described herein in connection with the door 3616 may be implemented in the context of the vehicle 100 or in other contexts.

The window 3614 is consistent with the description of the window 214, and the door 3616 is consistent with the description of the door 216, except as stated to the contrary herein. In the closed position (FIG. 36), the door 3616 is located in the opening 3606 and at least partially obstructs the opening. The window 3614 may also be located in the opening 3606 in the closed position and may cooperate with the door 3616 to fully obstruct the opening 3606. The door 3616 and the window 3614 may be positioned adjacent to a side portion 3610 of the vehicle body 3602 in the closed position. In the open position (FIGS. 37-38), the window 3614 is moved out of the opening 3606 (e.g., as previously described with reference to the window 214 or the window 1814), and the door 3616 has been pivoted outward and downward relative to the vehicle body 3602 and thus moved out of the opening 3606.

The door 3616 is an implementation of the door 216. The features and components previously described with respect to the door 216 and related components (e.g., components described with reference to FIGS. 1-17) may be used as a basis for implementing features and components of this implementation, and/or may be used in conjunction with this implementation. The window 3614 and related components may be implemented in the manner described with respect to previously described implementations (e.g., described with reference to FIGS. 1-35).

The door 3616 includes a frame 3650, and interior surface 3652, and an exterior surface 3653. The frame 3650 is a primary structural portion of the door 3616, which may be a single component or may include multiple components, and functions to support and interconnect other components of the door 3616. The interior surface 3652 faces an interior space 3603 (e.g., a passenger cabin) of the vehicle body 3602. As an example, the interior surface 3652 may be formed on the frame 3650 or may be formed on a component that is connected to the frame 3650, such as an interior trim panel. The exterior surface 3653 may be an exterior-facing aesthetic portion of the vehicle body 1802, such as a door skin, that is formed on the frame 3650 or connected to the frame 3650. The door 3616 extends from an upper end 3654 (e.g., adjacent to the window 3614) to a lower end 3655 (e.g., adjacent to a floor portion 3608 of the vehicle body 3602). A connecting structure 3656 is located at the lower end 3655 of the door 3616 for the purpose of connecting the door 3616 to the vehicle body 3602. As an example, the connecting structure 3656 may include a pivot joint, linkage, or other structure that pivotally connects the door 3616 to the vehicle body 3602. A movement mechanism 3620 is connected to vehicle body 3602 and is operably connected to the door 3616. The movement mechanism 3620 includes conventional components (e.g., powered actuators, couplers, linkages, cables, etc.) for generating and applying force to the door 3616 in order to move the door 3616 between the closed position and the open position. As an example, the movement mechanism 3620 may be implemented in the manner described with respect to the second movement mechanism 220.

In the open position (FIGS. 37-38), the door 3616 is pivoted outward and downward from the vehicle body 3602 relative to the closed position. Thus, for example, the door 3616 may be connected to the vehicle body 3602 at the lower end 3655 of the door 3616 and the upper end 3654 of the door 3616 may be located at a lower elevational position than a floor surface 3609 of the vehicle body 3602 when the door 3616 is in the open position.

During or subsequent to movement of the door 3616 to the open position, the stairway assembly 3622 may be moved from the stowed position (FIG. 36) to the deployed position (FIG. 37). In the deployed position, the stairway assembly 3622 may define one or more stairs that are usable for access (e.g., ingress or egress), e.g., to the vehicle 100. The stairway assembly 3622 includes a first movable stair tread 3758 and a second movable stair tread 3759 that are connected to the door 3616. The first movable stair tread 3758 and the second movable stair tread 3759 each have a first surface 3760 and a second surface 3761. The first surface 3760 and the second surface 3761 may be defined on opposite sides of the each of the first movable stair tread 3758 and the second movable stair tread 3759.

As will be explained further herein, the first movable stair tread 3758 and the second movable stair tread 3759 are each movable between a first position (FIG. 36) in which the first surface 3760 faces away from the door 3616 and is adjacent to the interior surface 3652 of the door, a second position in which the second surface 3761 faces away from the door 3616 and is spaced from and extends at an angle with respect to the interior surface 3652 of the door 3616 (FIG. 37), and a third position in which the second surface 3761 faces away from the door 3616 and is adjacent to the interior surface 3652 of the door (FIG. 38). In the first position and the third position, the first movable stair tread 3758 and the second movable stair tread 3759 are generally aligned with the door 3616 and/or the interior surface 3652 of the door 3616. In the second position, the first movable stair tread 3758 and the second movable stair tread 3759 extend at an angle with respect to the door 3616.

In the second position, the first movable stair tread 3758 and the second movable stair tread 3759 are configured to function as stairs for allowing access to the vehicle 100. To serve as stairs, the second surface 3761 of each of the first movable stair tread 3758 and the second movable stair tread 3759 each define and function as a walking surface portion for allowing access to the vehicle 100. The first surface 3760 of each of the first movable stair tread 3758 and the second movable stair tread 3759 do not function as walking surfaces, allowing them to remain clean to enhance the user's experience since the first surface 3760 of each of the first movable stair tread 3758 and the second movable stair tread 3759 is oriented toward and viewable from the interior space 3603 of the vehicle body 3602.

During or subsequent to movement of the door 3616 to the open position, the movable ramp 3626 may be moved from the stowed position (FIG. 36) to the deployed position (FIG. 38) by movement of a ramp portion 3864 out of the door 3616. In the deployed position, the ramp portion 3864 defines a walking surface portion 3866 that is usable for access (e.g., ingress or egress). When the movable ramp 3626 is moved to the deployed position, the first movable stair tread 3758 and the second movable stair tread 3759 are moved to the third position, in which the second surface 3761 faces away from the door 3616 to define walking surface portions that are disposed in alignment with the interior surface 3652 of door 3616 and are in alignment with the walking surface portion 3866 of the ramp portion 3864 so that they cooperate to define a walking surface for access to the vehicle 100. It should be noted, however, that although the second surface 3761 of each of the first movable stair tread 3758 and the second movable stair tread 3759 defines a walking surface for use as part of a ramp surface in this implementation, the same function could also be performed by movable structures that move between the first and third positions, but do not function as stair treads.

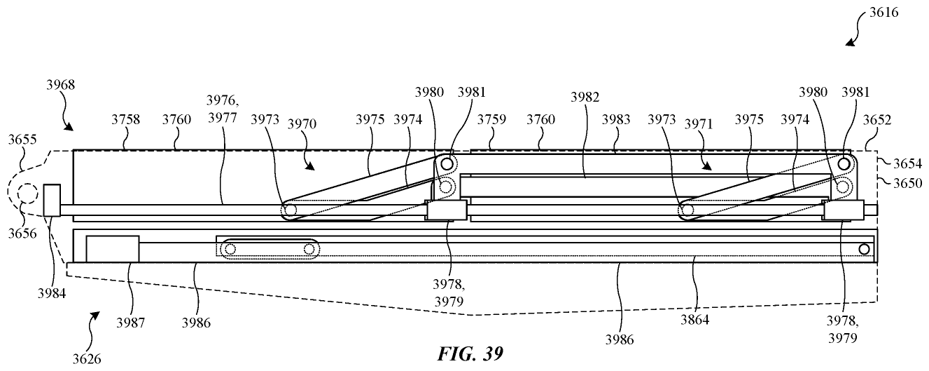

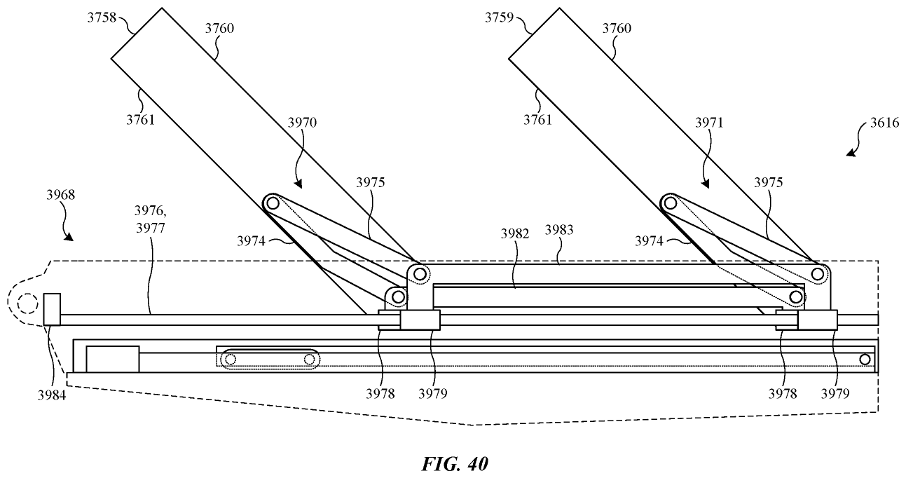

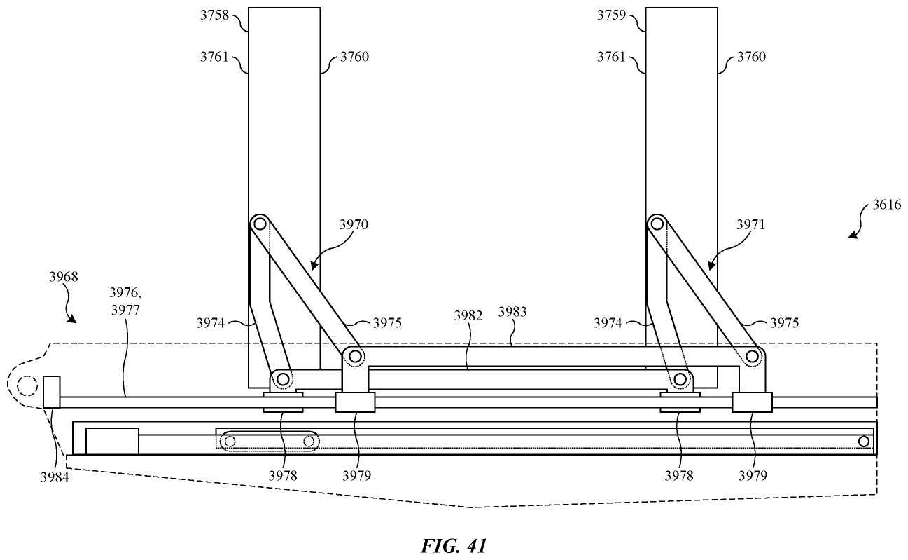

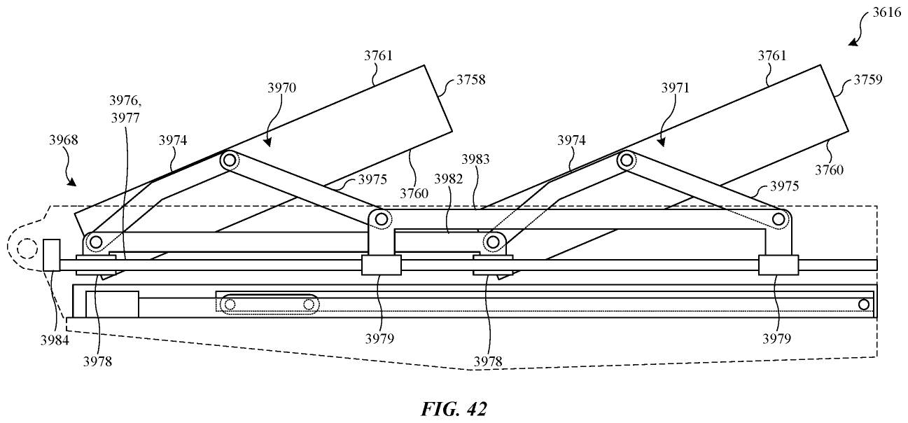

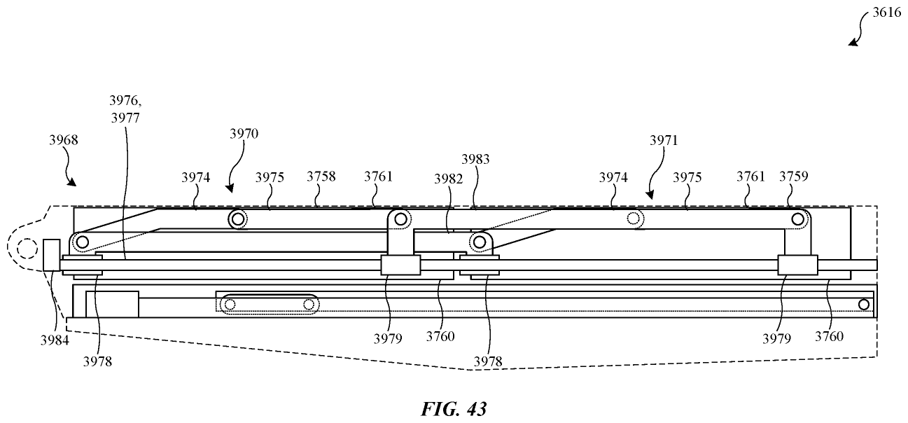

FIGS. 39-43 are schematic illustrations that show movement of the first movable stair tread 3758 and the second movable stair tread 3759 of the stairway assembly 3622 between the first position, the second position, and the third position. FIG. 39 shows the first movable stair tread 3758 and the second movable stair tread 3759 in the first position. FIG. 40 shows the first movable stair tread 3758 and the second movable stair tread 3759 in a first intermediate position between the first position and the second position. FIG. 41 shows the first movable stair tread 3758 and the second movable stair tread 3759 in a second intermediate position between the first intermediate position and the second position. FIG. 42 shows the first movable stair tread 3758 and the second movable stair tread 3759 in the second position. FIG. 43 shows the first movable stair tread 3758 and the second movable stair tread 3759 in the third position.

The stairway assembly 3622 includes a stair movement mechanism 3968 that connects the first movable stair tread 3758 and the second movable stair tread 3759 to the door 3616 and is configured to move the first movable stair tread 3758 and the second movable stair tread 3759 between the first position, the second position, and the third position.

The stair movement mechanism 3968 includes a first linkage 3970, a second linkage 3971 (together, a linkage or a linkage assembly). The first linkage 3970 is connected to and supported by the frame 3650 of the door 3616, and is also connected to the first movable stair tread 3758. The second linkage 3971 is connected to and supported by the frame 3650 of the door 3616, and is also connected to the second movable stair tread 3759. The first linkage 3970 and the second linkage 3971 may be implemented in the same manner, and the implementation of the first linkage 3970, as will be described herein, is equally applicable to the second linkage 3971.

In the illustrated implementation, the first linkage 3970 includes a first link 3974 and a second link 3975 that are each connected to the first movable stair tread 3758. In the illustrated implementation, the position and orientation of the first link 3974 is fixed with respect to the first movable stair tread 3758. Alternative configurations of the first linkage 3970 may include pivoting and/or sliding or the first link 3974 with respect to the first movable stair tread 3758. In the illustrated implementation, the second link 3975 is connected to the first movable stair tread 3758 by a pivot joint 3973 and is able to pivot with respect to the first movable stair tread 3758 during movement of the first movable stair 3758 tread between the first, second, and third positions.

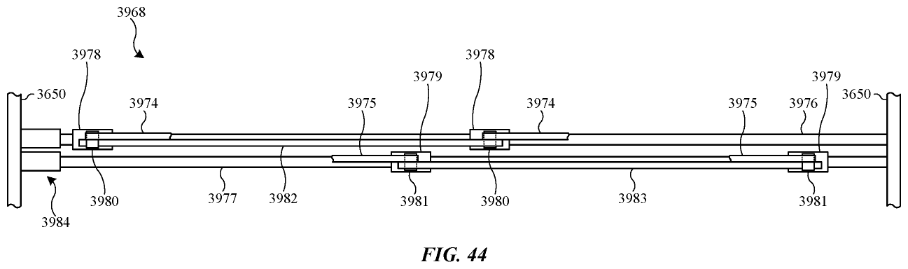

As best seen in FIG. 44, to control movement of the first linkage 3970, the stair movement mechanism 3968 includes a first guide structure 3976, a second guide structure 3977, a first slide member 3978, and a second slide member 3979. The first guide structure 3976 and the second guide structure 3977 are linear guides of any type that is configured to guide linear motion of the first slide member 3978 and the second slide member 3979, such as rails, rods, tracks screws, etc. In the illustrated implementation, the first slide member 3978 is connected to the first guide structure 3976 for sliding motion with respect to it, and the second slide member 3979 is connected to the second guide structure 3977 for sliding motion with respect to it. In an alternative implementation, the first slide member 3978 and the second slide member 3979 may be connected to a single guide structure.

The first slide member 3978 is pivotally connected to the first link 3974 by a pivot joint 3980, and the second slide member 3979 is pivotally connected to the second link 3975 by a pivot joint 3981. In the illustrated example, the stair movement mechanism includes a first connecting structure 3982 and a second connecting structure 3983 (e.g., bars, links, rods, or other rigid structures) that interconnect the first linkage 3970 and the second linkage 3971 for movement in unison, which extend between the first slide member 3978 and the second slide member 3979 of the first linkage 3970, and like components of the second linkage 3971. As illustrated the pivot joint 3980 and the pivot joint 3981 are located on the first connecting structure 3982 and the second connecting structure 3983, but may be located differently in other implementations and function in the manner described herein.

The stair movement mechanism also includes an actuator assembly 3984. The actuator assembly 3984 drives movement of the first linkage 3970 and the second linkage 3971 to cause the stair movement mechanism 3968 to move the first movable stair tread 3758 and the second movable stair tread 3759 between the first position and the second position. The actuator assembly 3984 may be connected to and supported by the frame 3650 of the door 3616. The actuator assembly 3984 may include, for example, a powered actuator (e.g., an electric motor or other powered prime mover) and force transfer components such as a screw drive, cables, rods, linkages, etc.

Starting from the first position, the first movable stair tread 3758 and the second movable stair tread 3759 are positioned so the first surface 3760 of each is oriented away from and faces outward from the door 3616, while the second surface 3761 of each faces inward toward the interior of the door 3616. In the first position, the first slide member 3978 is positioned longitudinally (e.g., at a position along the length of the first guide structure 3976) near the second slide member 3979 for the respective one of the first linkage 3970 or the second linkage 3971. As the actuator assembly 3984 drives movement of the first slide member 3978 and the second slide member 3979 of the first linkage 3970, the first slide member 3978 moves away from the second slide member 3979. This relative movement induces rotation of the first movable stair tread 3758 so that an outer end of the first movable stair tread 3758 pivots away from the interior surface 3652 of the door 3616, as shown in FIG. 40. This rotation continues as the first slide member 3978 continues to move away from the second slide member 3979, and the first movable stair tread 3758 moves through a perpendicular position (FIG. 40) relative to the door 3616, before reaching the second position, in which the first movable stair tread 3758 moves to an angle relative to the door 3616 at which the first movable stair tread 3758 is usable as a stair step to allow access to the vehicle 100. Upon continued movement of the first slide member 3978 away from the second slide member 3979, the first movable stair tread 3758 moves in to alignment with the door 3616, thereby reach the third position. Relative to the first position, the orientation of the first movable stair tread 3758 has flipped, and the second surface 3761 is now is oriented away from and faces outward from the door 3616. The first movable stair tread 3758 and the second movable stair tread 3759 may be returned to the first position by reversing the process.

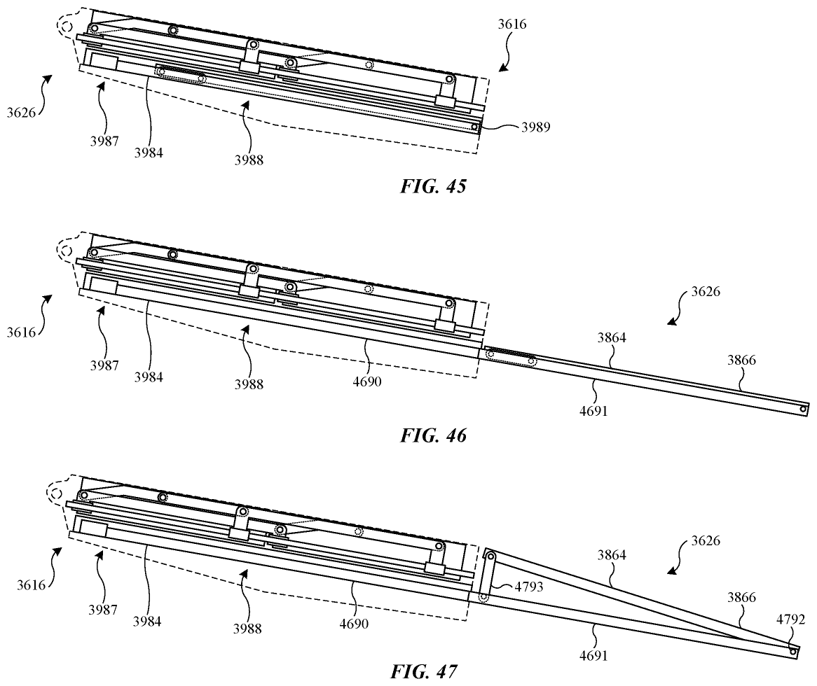

FIGS. 45-47 are schematic illustrations of the ramp portion 3864 of the movable ramp 3626. The movable ramp 3626 is illustrated during movement from the stowed position (FIG. 45), to and intermediate position (FIG. 46), and to a deployed position (FIG. 47).

As best seen in FIG. 39, the movable ramp 3626 includes a ramp housing 3986, an actuator assembly 3987, and an extension assembly 3988. The ramp housing 3986 is located in the frame 3650 of the door 3616 and defines a space inside the door 3616 that is configured to store the ramp portion 3864 of the movable ramp 3626 when it is not in use. The ramp housing 3986 may be located inside the door 3616 between the stairway assembly 3622 and the exterior surface 3653 of the door 3616, and may extend generally in the elevational direction Z of the vehicle body 3602. The ramp housing 3986 has an open end 3989 that is located near the upper end 3654 of the door 3616. The ramp portion 3864 is movable relative to the ramp housing 3986 (e.g., into and out of the ramp housing 3986) between the stowed position and the deployed position of the movable ramp 3626, which may also be referred to as stowed a deployed positions of the ramp portion 3864 In the stowed position, the ramp portion 3864 is located inside the ramp housing 3986. In the deployed position, at least part of the ramp portion 3864 extends out of the open end 3989 of the ramp housing 3986 to define the walking surface portion 3866 (e.g., a first walking surface portion) for allowing access to the vehicle 100. In the illustrated implementation, the ramp portion 3864 is located entirely outside of the ramp housing 3986 in the deployed position, and is connected to the door 3616 and supported by the extension assembly 3988, which is connected to the ramp housing 3986 and extends out of the ramp housing 3986 in the deployed position.

The actuator assembly 3987 of the movable ramp 3626 may be connected to and supported by the ramp housing 3986 and/or by the frame 3650 of the door 3616. The actuator assembly 3987 may include, for example, a powered actuator (e.g., an electric motor or other powered prime mover) and force transfer components such as a screw drive, cables, rods, linkages, etc., that are connected to the extension assembly 3988 and are configured to cause movement of the extension assembly 3988 and the ramp portion 3864. The extension assembly 3988 includes support structures that are movable relative to the door 3616 for supporting the ramp portion 3864 as it moves between the stowed and deployed positions, and may include tracks, rods, rails, beams, telescoping structures, etc.

Starting from the stowed position (FIG. 45), the ramp portion 3864 is initially located inside the ramp housing 3986. The door 3616 is in the open position or is moving toward the open position during movement of the ramp portion 3864 to the deployed position. The first movable stair tread 3758 and the second movable stair tread 3759 are disposed in the third position, as previously described, or are moving toward the third position during movement of the ramp portion 3864 to the third position.

To move the ramp portion 3864 toward the deployed position, the actuator assembly 3987 is activated to cause the extension assembly 3988 to translate out of the ramp housing 3986, causing corresponding translation of the ramp portion 3864 out of the ramp housing 3986, until the ramp portion 3864 is located outside of the ramp housing 3986 to define the intermediate position (FIG. 46). In the illustrated implementation, to move from the stowed position to the intermediate position, the extension assembly 3988 includes a first beam section 4690 and a second beam section 4691 that are slidable with respect to each other to slide out of the ramp housing 3986 and support the ramp portion 3864. The first beam section 4690 and the second beam section 4691 may be located adjacent to each other and connected by sliding joints, or may be telescopically connected, or may be related in any other suitable manner.

In the intermediate position, the walking surface portion 3866 of the ramp portion 3864 is aligned with the door 3616 and the ramp housing 3986, but is misaligned relative to the walking surface portions defined by the first movable stair tread 3758 and the second movable stair tread 3759, such that a gap is defined between an inner end of the ramp portion 3864 and the second surface 3761 of the second movable stair tread 3759. To align the inner end of the walking surface portion 3866 of the ramp portion 3864 with the second movable stair tread 3759, the ramp portion 3864 is pivoted to define the deployed position (FIG. 47). In the illustrated implementation, the ramp portion 3864 is connected, at its outer end, to the extension assembly 3988 by a pivot joint 4792. At the inner end of the ramp portion 3864, a pivot linkage 4793 of the extension assembly 3988 is operatively connected to (e.g., directly or indirectly connected to and/or engaged with) the ramp portion 3864 in order to cause pivoting of the ramp portion 3864 to bring the inner end of the ramp portion 3864 into alignment with the second movable stair tread 3759 and thereby establish the deployed position. As an example, the pivot linkage 4793 may be pivotally connected to the ramp portion 3864 and may pivot and slide with respect to a portion of the extension assembly 3988, such as the first beam section 4690 or the second beam section 4691. The ramp portion 3864 may be returned to the stowed position by reversing the process.

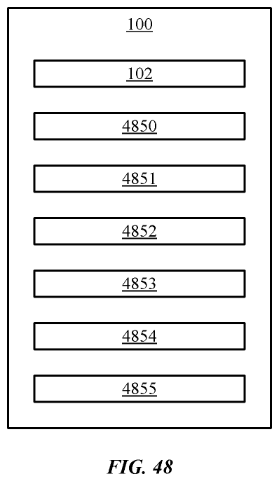

FIG. 48 is a block diagram that shows the vehicle 100. As an example, the vehicle 100 may be a conventional road-going vehicle that is supported by wheels and tires (e.g., four wheels and tires). As an example, the vehicle 100 may be a passenger vehicle that includes a passenger compartment that is configured to carry one or more passengers. In the illustrated implementation, the vehicle 100 includes the vehicle body 102, a suspension system 4850, a propulsion system 4851, a braking system 4852, a steering system 4853, a sensing system 4854, and a control system 4855. These are examples of vehicle systems that are included in the vehicle 100. Other systems can be included in the vehicle 100.

The vehicle body 102 includes structural components of the vehicle 100 through which other components are interconnected and supported as well as aesthetic components of the vehicle 100. The structural components of the vehicle body 102 may include, as examples, a frame, subframe, unibody, monocoque, etc. The aesthetic components of the vehicle body 102 may include exterior body panels, exterior trim panels, interior trim panels, fixtures, accessories, etc.

The suspension system 4850 controls vertical motion of the wheels of the vehicle 100 relative to the vehicle body 102, and may include passive suspension components and/or active suspension components. The propulsion system 4851 includes propulsion components that are configured to cause motion of the vehicle 100 (e.g., accelerating the vehicle 100), such as an internal combustion engine, one or more electric motors, a battery, an inverter, one or more gearboxes, etc. The braking system 4852 provides deceleration torque for decelerating the vehicle 100. The steering system 4853 is operable to cause the vehicle to turn by changing a steering angle of one or more wheels of the vehicle 100.

The sensing system 4854 includes sensors for observing external conditions of the environment around the vehicle 100 (e.g., location of the roadway and other objects) and conditions of the vehicle 100 (e.g., acceleration and conditions of the various systems and their components). The sensing system 4854 may include sensors of various types, including dedicated sensors and/or components of various systems.

The control system 4855 includes communication components (i.e., for receiving sensor signals and sending control signals) and processing components (i.e., for processing the sensor signals and determining control operations), such as a controller. The control system 4855 may be a single system or multiple related systems. For example, the control system 4855 may be a distributed system including components that are included in other systems of the vehicle 100.

The control system 4855 may include autonomous driving functions that are configured to control operation of vehicle actuator systems of the vehicle 100 without manual control inputs. As an example, the control system 4855 may use inputs received from the sensing system 4854 to understand the environment around the vehicle and may determine commands that are sent to one or more vehicle actuator systems, such as the propulsion system 4851, the braking system 4852, and the steering system 4853, to cause the vehicle 100 to travel from a current location toward a destination location.

The control system 4855 may exercise control over various systems and components of the vehicle 100, such as the closure assembly 104 and the movement mechanisms and actuators that are described herein. In this manner, the control system 4855 may cause and control movement of components between positions, such as by moving closures between open and closed positions, and by moving stairs or ramps between stowed and deployed positions. Certain types of control decisions may be made by the control system 4855 independent of user input, for example, using program instructions that direct the control system 4855 to move closures between positions when a set of conditions is satisfied. Certain types of control decisions may be made based on user input, such as by opening a closure in response to a user command and upon confirming that requisite conditions are satisfied (e.g., the vehicle 100 is not motion, etc.).

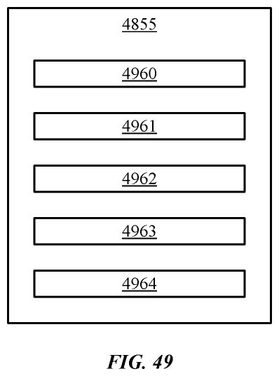

FIG. 49 is a block diagram that shows an example implementation of the control system 4855 and/or other computer-implemented systems of the vehicle 100. The control system 4855 may be a conventional computing device that includes include a processor 4960, a memory 4961, a storage device 4962, one or more input devices 4963, and one or more output devices 4964. The control system 4855 may include a bus or a similar device to interconnect the components for communication. The control system 4855 may include computer program instructions (e.g., stored on the storage device 4962) that are configured to cause the control system to perform the computer-implemented functions described herein with respect to the vehicle 100 and various systems thereof.

The processor 4960 is operable to execute computer program instructions and perform operations described by the computer program instructions. As an example, the processor 4960 may be a conventional device such as a central processing unit. The memory 4961 may be a volatile, high-speed, short-term information storage device such as a random-access memory module. The storage device 4962 may be a non-volatile information storage device such as a hard drive or a solid-state drive. The input devices 4963 may include any type of human-machine interface such as buttons, switches, a keyboard, a mouse, a touchscreen input device, a gestural input device, or an audio input device. The output devices 4964 may include any type of device operable to provide an indication to a user regarding an operating state, such as a display screen or an audio output, or any other functional output or control.

The closure assemblies, windows, doors, movement mechanisms, and other devices that are shown and described herein may be implemented in the context of a device that utilizes data obtained from users, from sensors, or from other sources during operation. This information may include personal information. Examples of personal information include, but are not limited to, information that identifies a person, information that can be used to identify a person, location information, and health and fitness information. Entities that implement this technology should only collect and/or store personal information if doing so benefits the user, such as by enhancing the user's experience. Furthermore, personal information should only be collected and/or stored with the user's consent, and the technology should be implemented in a way that maintains its functionality without use of personal information. Thus, the user should be able to “opt out” of collection and storage of personal information while maintaining functionality to the extent that it is possible to do so. To the extent that personal information is collected and/or stored, best practices should be followed to safeguard privacy of the personal information, such as by limiting use of the information to legitimate uses, ensuring that the information is not shared or sold for uses other than legitimate uses, limiting the time period over which the information is stored, storing the information in an anonymized or aggregated form, and adhering to any applicable laws or relevant industry standards. Policies describing usage and storage of personal information should be made available to users.

What is claimed is:

1. A vehicle closure, comprising:
a door that is configured for connection to a vehicle body for movement with respect to an opening of the vehicle body between a closed position and an open position;
a movable roof panel that is configured for connection to the vehicle body for movement with respect to the opening between a closed position and an open position by pivoting relative to the vehicle body; and
an access structure that is configured to be movable from a stowed position to a deployed position when the door is in the open position, wherein the access structure defines a walking surface in the deployed position.

2. The vehicle closure of claim 1, wherein the access structure includes a movable ramp that is located under a floor surface of the vehicle body in the stowed position.

3. The vehicle closure of claim 2, wherein the door is configured to be connected to the vehicle body for movement between the closed position and the open position by moving outward in a lateral direction of the vehicle body during a first motion phase and by moving in a longitudinal direction of the vehicle body during a second motion phase.

4. The vehicle closure of claim 3, wherein the movable ramp is configured to move between the stowed position and the deployed position by moving outward in the lateral direction of the vehicle body in correspondence with movement of the door during the first motion phase and by moving outward and downward relative to the vehicle body in a third motion phase.

5. The vehicle closure of claim 4, wherein an outer end of the movable ramp is positioned adjacent to the door in the first motion phase.

6. The vehicle closure of claim 4, wherein a gap of fifty millimeters or less is defined between an outer end of the movable ramp and the door during the first motion phase.

7. The vehicle closure of claim 1, wherein the door is configured to move between the closed position and the open position by pivoting downward and outward relative to the vehicle body, and the access structure includes a movable ramp that is located inside the door in the stowed position and extends outward from the door in the deployed position.

8. The vehicle closure of claim 1, wherein the door is configured to move between the closed position and the open position by pivoting downward and outward relative to the vehicle body, and the access structure includes a movable ramp that is located adjacent to an interior surface of the door in the stowed position and extends outward from the door in the deployed position.

9. The vehicle closure of claim 1, wherein the door is configured to move between the closed position and the open position by pivoting downward and outward relative to the vehicle body, the access structure includes a movable ramp, a first walking surface portion of the walking surface is defined by the door when the access structure is in the deployed position and a second walking surface portion of the walking surface is defined by the movable ramp when the access structure is in the deployed position.

10. The vehicle closure of claim 1, wherein the door is configured to move between the closed position and the open position by pivoting downward and outward relative to the vehicle body, and the access structure includes a movable ramp that is configured to translate with respect to the door during movement of the access structure from the stowed position to the deployed position.

11. The vehicle closure of claim 1, wherein the door is configured to move between the closed position and the open position by pivoting downward and outward relative to the vehicle body, and the access structure includes a movable ramp that is configured to pivot with respect to the door during movement of the access structure from the stowed position to the deployed position.

12. The vehicle closure of claim 1,
wherein the access structure includes a movable ramp, the access structure includes a stairway assembly, and movement of the access structure from the stowed position to the deployed position includes movement of a selected one of the movable ramp or the stairway assembly to a respective deployed position, and
wherein the movable ramp is located inside the door in the stowed position of the access structure and the stairway assembly is located adjacent to an interior surface of the door in the stowed position of the access structure.

13. A vehicle closure, comprising:
a door that is configured for connection to a vehicle body for movement with respect to an opening of the vehicle body between a closed position and an open position; and
an access structure that is movable from a stowed position to a deployed position when the door is in the open position,
wherein the access structure defines a walking surface in the deployed position, and
wherein the door is configured to move between the closed position and the open position by pivoting downward and outward relative to the vehicle body, the access structure includes a stairway assembly that includes movable stair treads that are connected to the door and move with respect to the door during movement of the access structure between the stowed position and the deployed position, and each of the movable stair treads defines a walking surface portion of the walking surface when the access structure is in the deployed position.

14. The vehicle closure of claim 12, wherein the movable stair treads are positioned adjacent to the door when the access structure is in the stowed position and the movable stair treads are disposed at an angle relative to the door when the access structure is in the deployed position.

15. The vehicle closure of claim 13, further comprising:
a stair movement mechanism that is configured to connect the movable stair tread to the door and is configured to move the movable stair tread between the stowed position and the deployed position.

16. A vehicle closure, comprising:
a door that is configured for connection to a vehicle body for movement between a closed position and an open position by pivoting outward and downward relative to an opening defined by the vehicle body; and
a window that is configured for connection to the vehicle body for movement between a closed position and an open position, wherein the window and the door are configured to move independently.

17. The vehicle of claim 16, wherein the window is configured to be connected to the vehicle body by a movement mechanism that is operable to move the window between the closed position and the open position by pivoting the window upward and inward relative to the vehicle body.

18. The vehicle of claim 16, wherein the window is configured to be connected to the vehicle body by a movement mechanism that is operable to move the window between the closed position and the open position by translation of the window longitudinally relative to the vehicle body.

19. The vehicle of claim 16, further comprising:
a movable ramp that is connected to the door and is configured to be movable between a stowed position and a deployed position with respect to the door, wherein the movable ramp defines a walking surface in the deployed position.

20. The vehicle of claim 16, further comprising:
a stairway assembly that includes movable stair treads that are connected to the door and are configured to move with respect to the door between a stowed position and a deployed position, wherein each of the movable stair treads defines a walking surface portion in the deployed position.
